(19) United States
(12) Patent Application Publication
(10) Pub. No.: US 2025/0088232 A1
(43) Pub. Date: Mar. 13, 2025

(54) TRANSMISSION SPATIAL INFORMATION FOR CHANNEL ESTIMATION

(71) Applicant: QUALCOMM Incorporated, San Diego, CA (US)

(72) Inventors: Chenxi HAO, Beijing (CN); Yu ZHANG, San Diego, CA (US); Rui HU, Beijing (CN); Wei XI, Beijing (CN); Taesang YOO, San Diego, CA (US); Hao XU, Beijing (CN)

(21) Appl. No.: 18/728,394

(22) PCT Filed: Apr. 2, 2022
(86) PCT No.: PCT/CN2022/085026

§ 371 Date: Jul. 11, 2024

(51) Int. Cl. H04B 7/06

(52) U.S. Cl. CPC H04B 7/0617; H04B 7/0626; H04B 7/06968

(57) ABSTRACT

Certain aspects of the present disclosure provide techniques for channel estimation based on transmission spatial information. An example method of wireless communication by a user equipment includes receiving an indication of transmission spatial information associated with a network entity; receiving a reference signal from the network entity based on the transmission spatial information; and transmitting, to the network entity, channel state information (CSI) based on the received reference signal and the transmission spatial information.

### INTRODUCTION

Aspects of the present disclosure relate to wireless communications, and more particularly, to techniques for channel estimation and/or channel state information reporting.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

The systems, methods, and devices of the disclosure each have several aspects, no single one of which is solely responsible for its desirable attributes. After considering this discussion, and particularly after reading the section entitled “Detailed Description” one will understand how the features of this disclosure provide advantages that include transmission spatial information identifying ports with a reduced frequency bandwidth.

Certain aspects of the subject matter described in this disclosure can be implemented in a method for wireless communication by a user equipment (UE). The method generally includes receiving an indication of transmission spatial information associated with a network entity; receiving a reference signal from the network entity based on the transmission spatial information; and transmitting, to the network entity, channel state information (CSI) based on the received reference signal and the transmission spatial information.

Certain aspects of the subject matter described in this disclosure can be implemented in a method for wireless communication by a network entity. The method generally includes outputting an indication of transmission spatial information associated with the network entity; outputting a reference signal based on the transmission spatial information; and obtaining channel state information (CSI) based on the reference signal and the transmission spatial information.

Certain aspects of the subject matter described in this disclosure can be implemented in an apparatus for wireless communication. The apparatus generally includes a memory and a processor coupled to the memory. The processor is configured to receive an indication of transmission spatial information associated with a network entity; receive a reference signal from the network entity based on the transmission spatial information; and transmit, to the network entity, channel state information (CSI) based on the received reference signal and the transmission spatial information.

Certain aspects of the subject matter described in this disclosure can be implemented in an apparatus for wireless communication. The apparatus generally includes a memory and a processor coupled to the memory. The processor is configured to output an indication of transmission spatial information associated with the apparatus, output a reference signal based on the transmission spatial information, and obtain channel state information (CSI) based on the reference signal and the transmission spatial information.

Certain aspects of the subject matter described in this disclosure can be implemented in an apparatus for wireless communication. The apparatus generally includes means for receiving an indication of transmission spatial information associated with a network entity; means for receiving a reference signal from the network entity based on the transmission spatial information; and means for transmitting, to the network entity, channel state information (CSI) based on the received reference signal and the transmission spatial information.

Certain aspects of the subject matter described in this disclosure can be implemented in an apparatus for wireless communication. The apparatus generally includes means for outputting an indication of transmission spatial information associated with the network entity; means for outputting a reference signal based on the transmission spatial information; and means for obtaining channel state information (CSI) based on the reference signal and the transmission spatial information.

Certain aspects of the subject matter described in this disclosure can be implemented in a computer-readable medium. The computer-readable medium has instructions stored thereon, that when executed by an apparatus, cause the apparatus to perform operations including receiving an indication of transmission spatial information associated with a network entity; receiving a reference signal from the network entity based on the transmission spatial information; and transmitting, to the network entity, channel state information (CSI) based on the received reference signal and the transmission spatial information.

Certain aspects of the subject matter described in this disclosure can be implemented in a computer-readable medium. The computer-readable medium has instructions stored thereon, that when executed by an apparatus, cause the apparatus to perform operations including outputting an indication of transmission spatial information associated with the network entity; outputting a reference signal based on the transmission spatial information; and obtaining channel state information (CSI) based on the reference signal and the transmission spatial information.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example of a base station and user equipment.

FIGS. 3A, 3B, 3C, and 3D depict various example aspects of data structures for a wireless communication network.

FIG. 4 shows a diagram illustrating an example disaggregated base station architecture.

FIG. 5 is a diagram illustrating an example wireless communication network using transmission spatial information.

FIG. 6 is a diagram illustrating an example artificial intelligence architecture, for example, using a neural network to determine a channel estimation.

FIG. 7A is a diagram illustrating an example channel state information feedback operation across a user equipment and base station.

FIG. 7B is a diagram illustrating an example artificial intelligence architecture, for example, using a neural network to encode channel state information at a user equipment and a neural network at a base station to decode the channel state information into a precoder.

FIG. 8 is a diagram illustrating an example spatial correlation for an antenna architecture having eight by eight cross-polarized antenna elements.

FIG. 9 is a diagram illustrating an example spatial correlation for an antenna architecture having four by sixteen cross-polarized antenna elements.

FIG. 10 is a diagram illustrating another example spatial correlation for an antenna architecture having four by sixteen cross-polarized antenna elements.

FIG. 11 is a signaling flow diagram illustrating an example of indicating transmission spatial information via a cover-code configuration.

FIG. 12 is a signaling flow diagram illustrating an example of indicating transmission spatial information via a machine learning module associated with a cover-code.

FIG. 13 is a signaling flow diagram illustrating an example of indicating transmission spatial information via quasi co-location information.

FIG. 14 is a signaling flow diagram illustrating an example of indicating transmission spatial information via an in-distribution configuration for machine learning modules associated with a base station.

FIG. 15 is a signaling flow diagram illustrating another example of indicating transmission spatial information via an in-distribution configuration for machine learning modules associated with multiple base stations.

FIG. 16 is a signaling flow diagram illustrating an example of indicating transmission spatial information.

FIG. 17 illustrates an example networked environment in which a predictive model is used for channel estimation and/or generating channel state information.

FIG. 18 is a flow diagram illustrating example operations for wireless communication, for example, by a user equipment.

FIG. 19 is a flow diagram illustrating example operations for wireless communication, for example, by a network entity.

FIG. 20 depicts aspects of an example communications device.

FIG. 21 depicts aspects of an example communications device.

### DETAILED DESCRIPTION

Aspects of the present disclosure provide apparatuses, methods, processing systems, and computer-readable mediums for channel estimation.

Wireless communication networks (e.g., 5G New Radio (NR) systems or other wireless systems) may use channel state information (CSI) feedback from a user equipment (UE) for adaptive communications. A network entity (e.g., a base station) may adjust certain communication parameters at a UE in response to CSI feedback from the UE. For example, link adaptation (such as adaptive modulation and coding and/or power control) with various modulation schemes and channel coding rates may be applied to certain communication channels. For channel state estimation purposes, the UE may be configured to measure a reference signal (e.g., a CSI reference signal (CSI-RS)) and estimate the downlink channel state based on the CSI-RS measurements. The UE may report an estimated channel state to the network in the form of CSI, which may be used in link adaptation. The CSI may indicate channel properties of a communication link between a BS and a UE. The CSI may represent the effect of, for example, scattering, fading, and pathloss of a signal across the communication link.

In certain cases, a network entity (such as a base station (BS)) may have an antenna array with a large number of antenna elements (e.g., greater than 100 antenna elements). For example, the network entity may have upwards of 10,000 antenna elements, for example, for holographic multiple-input multiple-output (MIMO) communications and/or in a programmable reflective surface, such as a reconfigurable intelligent surface (RIS). In accordance with some examples, a network entity may be deployed with a large number of transceiver units (TxRUs), for example, greater than 32 TxRUs. A TxRU may be representative of the beamforming (e.g., amplitude and phase control) associated with a group of physical antenna elements in an antenna array. A TxRU may correspond to one or more antenna elements in an antenna array. In certain cases, antenna port (or merely port) may refer to a TxRU. The large number of antenna elements and/or TxRUs deployed at a network entity may facilitate beamforming and/or multi-user MIMO, such as steering multiple radiation patterns from a radio unit in different directions towards users.

In certain wireless communication networks (e.g., a 5G New Radio (NR) system), a certain number of antenna ports (e.g., TxRUs) may occupy the same number of resource elements per resource block, where a resource element is representative of a subcarrier (e.g., a number of consecutive subcarriers), and a resource block is a certain number of resource elements (e.g., 12 resource elements). Each antenna port may be associated with a resource element. 5G NR systems may support a network entity with antenna architectures having up to 32 antenna ports. Under such a configuration, the UE may perform channel estimation on up to 32 antenna ports occupying the same number of resource elements. The channel estimation processing complexity at a UE may be proportional to the frequency bandwidth associated with the ports. As the number of ports increase, the UE may be tasked to process an increasing frequency bandwidth associated with the ports for channel estimation and/or CSI reporting. In certain cases, the UE may not have the capability to process the corresponding frequency bandwidth associated with a large number of ports and corresponding antenna elements associated with a network entity.

Aspects of the present disclosure provide methods and apparatus for using transmission spatial information associated with channel estimation and/or reporting CSI. The transmission spatial information may indicate a mapping of TxRUs to antenna elements of an antenna architecture. In accordance with one or more examples, a network entity may send (for example, to a UE) an indication of the transmission spatial information associated with a certain network entity, and the UE may use the transmission spatial information to determine a channel estimation and/or CSI, as further described herein. The transmission spatial information may identify a cover-code associated with a resource block where P ports map to L resource elements (RE) per resource block. The cover-code may indicate the beamforming applied to a signal, such as the amplitude and phase control. The number of resource elements L is less than the number of ports, for example, where {P, L}={32, 8} or {128, 32}. In some cases, the cover-code may be different on different resource blocks, and CSI-RS are transmitted on K resource blocks out of total N resource blocks. In other cases, the cover-code may span multiple resource blocks or an entire frequency band, for example, occupying K resource blocks out of total N resource blocks with L REs per resource block. Such a cover-code may facilitate multiplexing P ports on total K*L REs across an entire frequency band, and the UE may recover the channel of P ports on all N resource blocks. In some cases, the UE may use machine learning to determine the channel estimation and/or CSI based on the transmission spatial information.

The transmission spatial information described herein may facilitate CSI-RS overhead reduction with usage of a machine learning module to perform channel estimation and/or determine CSI and reduce the CSI-RS overhead. The transmission spatial information may be used to train, select, and/or configure the machine learning module.

In some cases, the transmission spatial information may indicate P ports map to L resource elements per resource block, where the number of resource elements L is less than the number of ports. The transmission spatial information described herein may facilitate machine learning at the UE, for example, due to a reduced frequency resource occupation (e.g., the number of resource elements L) associated with the number of CSI-RS ports represented by the transmission spatial information.

The transmission spatial information described herein may facilitate flexible configurations at the network and/or UE, such as a flexible TxRU to antennal element mapping configuration at the network entity and/or a flexible machine learning configuration at the UE. For example, the transmission spatial information may allow for unique antenna architectures at the network entity, where the transmission spatial information indicates a standardized mapping for TxRUs. The transmission spatial information may allow for unique machine learning models at the UE, where the transmission spatial may be used to train, select, and/or configure the machine learning model

### Introduction to Wireless Communication Networks

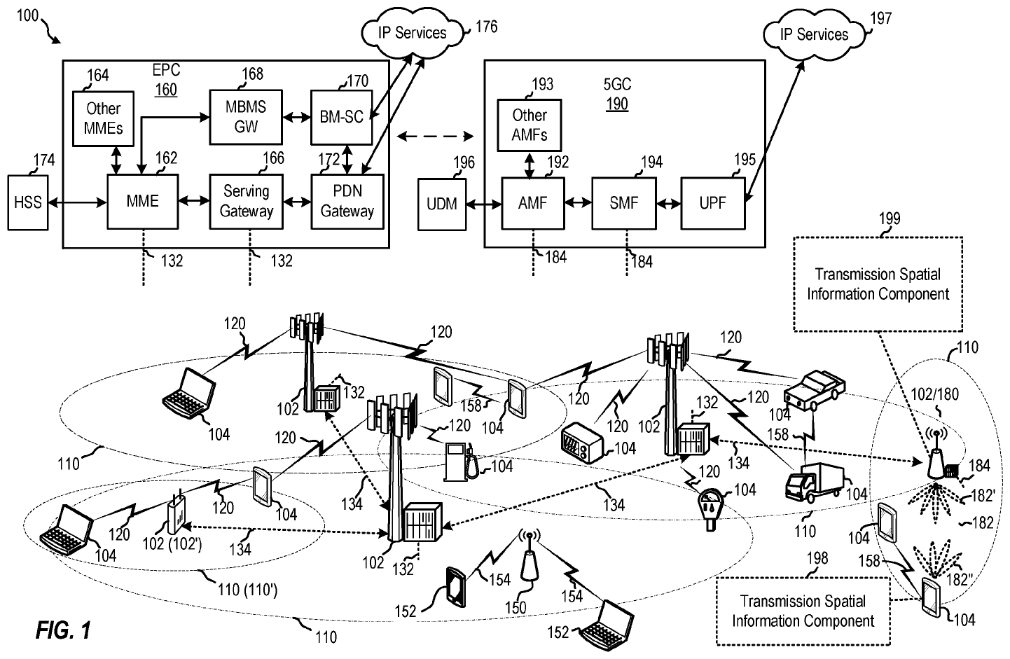

FIG. 1 depicts an example of a wireless communication network 100, in which aspects described herein may be implemented. Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. In this example, wireless communication network 100 includes base stations (BSs) 102, user equipments (UEs) 104, one or more core networks, such as an Evolved Packet Core (EPC) 160 and 5G Core (5GC) network 190, which interoperate to provide wireless communications services.

BSs 102 may provide an access point to the EPC 160 and/or 5GC 190 for a UE 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a network entity, gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

A base station, such as BS 102, may include components that are located at a single physical location or components located at various physical locations. In examples in which the base station includes components that are located at various physical locations, the various components may each perform various functions such that, collectively, the various components achieve functionality that is similar to a base station that is located at a single physical location. As such, a base station may equivalently refer to a standalone base station or a base station including components that are located at various physical locations or virtualized locations. In some implementations, a base station including components that are located at various physical locations may be referred to as or may be associated with a disaggregated radio access network (RAN) architecture, such as an Open RAN (O-RAN) or Virtualized RAN (VRAN) architecture. In some implementations, such components of a base station may include or refer to one or more of a central unit (CU), a distributed unit (DU), or a radio unit (RU).

BSs 102 wirelessly communicate with UEs 104 via communications links 120. Each of BSs 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

Wireless communication network 100 includes a transmission spatial information component 199, which may be configured to indicate transmission spatial information associated with a network entity. Wireless communication network 100 further includes a transmission spatial information component 198, which may be configured to determine a channel estimation and/or channel state information based on the transmission spatial information.

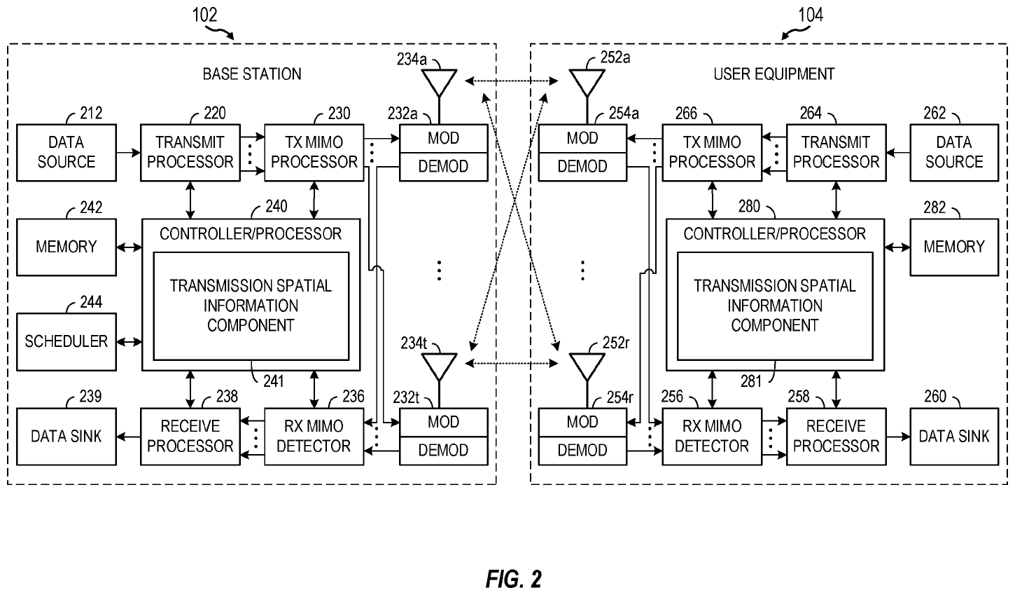

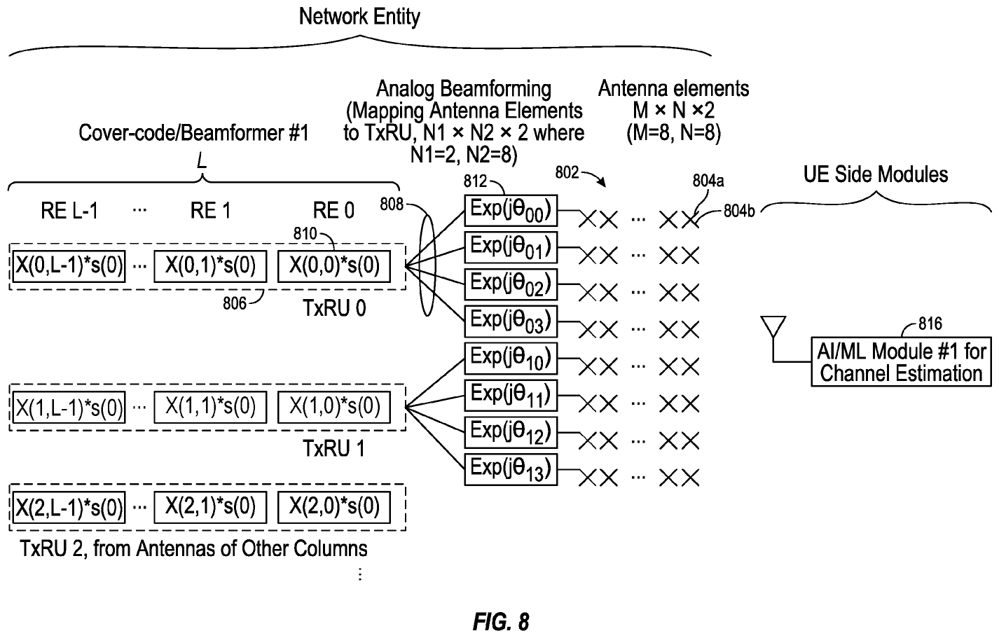

FIG. 2 depicts aspects of an example BS 102 and a UE 104. Generally, BS 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 102 may send and receive data between itself and UE 104. In certain cases, the BS 102 may output an indication of transmission spatial information associated with the antenna 234a-t, and the UE 104 may use the transmission spatial information to determine a channel estimation and/or CSI, as further described herein. In certain aspects, the antennas 234a-t may be arranged in an antenna architecture as further described herein with respect to FIGS. 8-10.

BS 102 includes controller/processor 240, which may be configured to implement various functions related to wireless communications. In the depicted example, controller/processor 240 includes a transmission spatial information component 241, which may be representative of the transmission spatial information component 199 of FIG. 1. Notably, while depicted as an aspect of controller/processor 240, the transmission spatial information component 241 may be implemented additionally or alternatively in various other aspects of BS 102 in other implementations.

Generally, UE 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

UE 104 includes controller/processor 280, which may be configured to implement various functions related to wireless communications. In the depicted example, controller/processor 280 includes a transmission spatial information component 281, which may be representative of the transmission spatial information component 198 of FIG. 1. Notably, while depicted as an aspect of controller/processor 280, the transmission spatial information component 281 may be implemented additionally or alternatively in various other aspects of UE 104 in other implementations.

While the user equipment 104 is described with respect to FIGS. 1 and 2 as communicating with a base station and/or within a network, the user equipment 104 may be configured to communicate directly with/transmit directly to another user equipment 104, or with/to another wireless device without relaying communications through a network. In some aspects, the base station 102 illustrated in FIG. 2 and described above is an example of another user equipment 104, or vice versa.

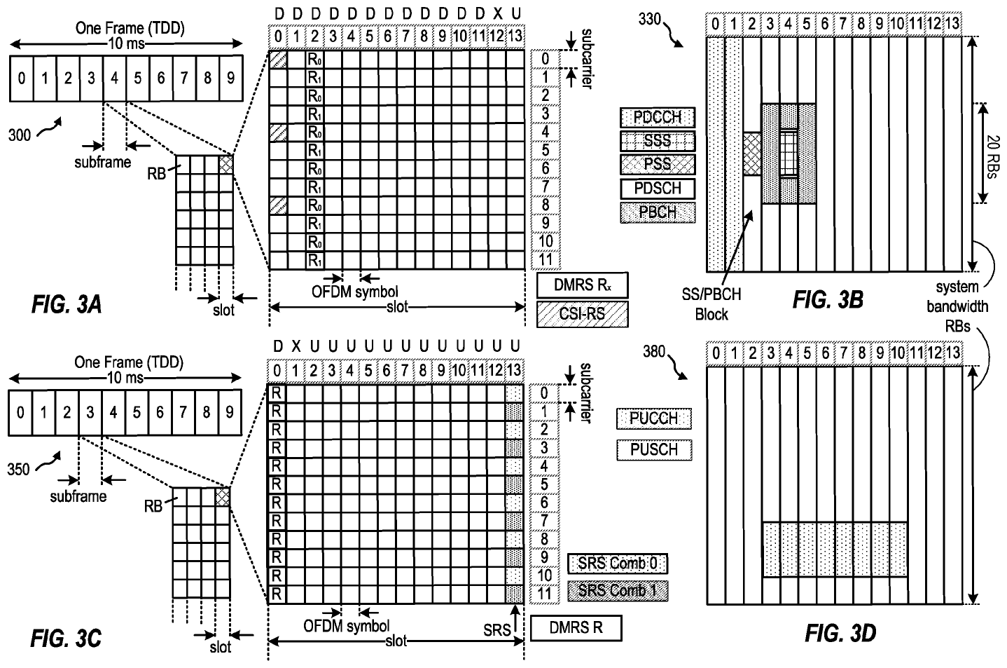

FIGS. 3A, 3B, 3C, and 3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station. A network entity or network node can be implemented as an aggregated base station, as a disaggregated base station, a component of a base station, an integrated access and backhaul (IAB) node, a relay node, a sidelink node, to name a few examples.

An aggregated base station may be configured to utilize a radio protocol stack that is physically or logically integrated within a single RAN node. A disaggregated base station may be configured to use a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN), also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

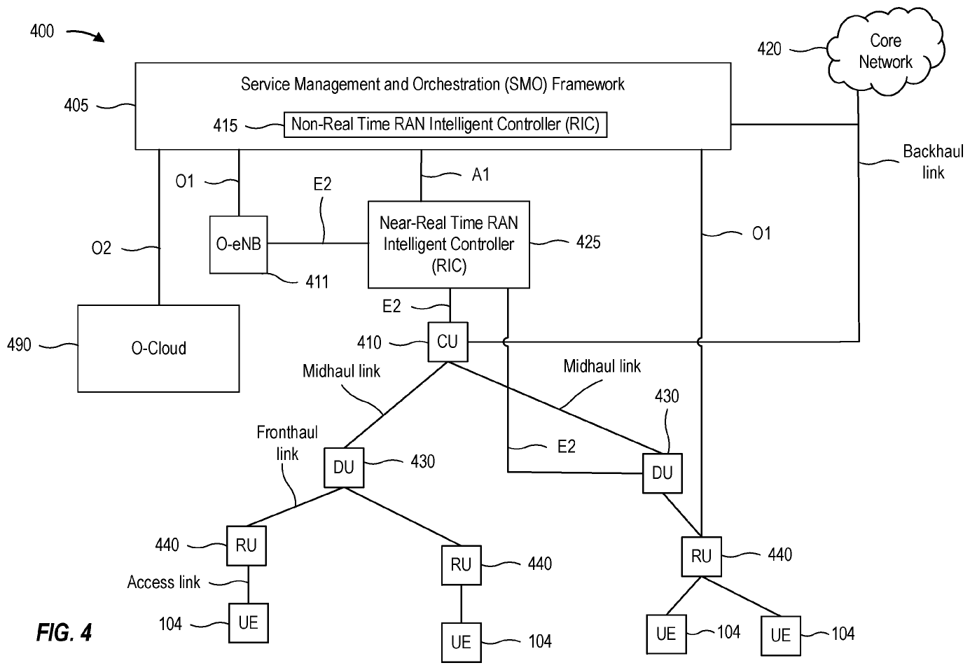

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

In various aspects, a network entity or network node can be implemented as an aggregated base station, as a disaggregated base station, a component of a base station, an integrated access and backhaul (IAB) node, a relay node, a sidelink node, to name a few examples.

Further discussions regarding FIG. 1, FIG. 2, FIGS. 3A, 3B, 3C, and 3D, and FIG. 4 are provided later in this disclosure.

Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Communications using mm Wave/near mmWave radio frequency band (e.g., 3 GHz-300 GHz) may have higher path loss and a shorter range compared to lower frequency communications. As described above with respect to FIG. 1, a base station (e.g., 180) configured to communicate using mmWave/near mmWave radio frequency bands may utilize beamforming (e.g., 182) with a UE (e.g., 104) to improve path loss and range.

Further, as described herein, a UE may estimate a channel or generate channel state information in mmWave bands and/or other frequency bands using transmission spatial information.

### Aspects Related to Transmission Spatial Information for Channel Estimation

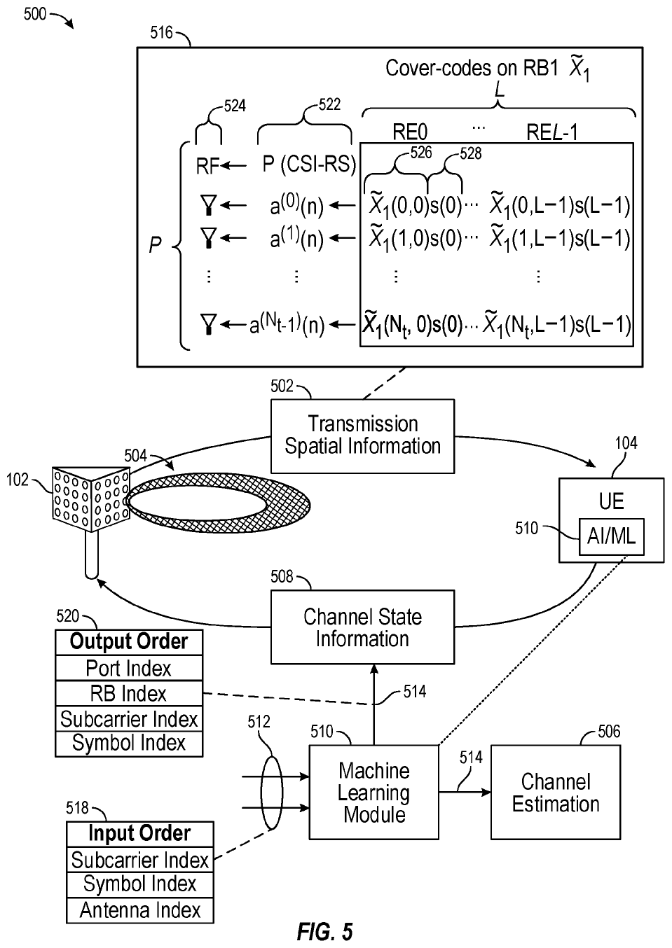

Aspects of the present disclosure provide methods and apparatus for using transmission spatial information associated with channel estimation and/or reporting channel state information (CSI). The transmission spatial information may indicate a mapping of transceiver units (TxRUs) to antenna elements of an antenna architecture. In accordance with one or more examples, a network entity may output (for example, to a UE) an indication of the transmission spatial information associated with a certain network entity, and the UE may use the transmission spatial information to determine a channel estimation and/or CSI, as further described herein. In some cases, the UE may use machine learning to determine the channel estimation and/or CSI based on the transmission spatial information, for example, as further described herein with respect to FIG. 5.

The transmission spatial information described herein may facilitate CSI-RS overhead reduction with usage of a machine learning module to perform channel estimation and/or determine CSI and reduce the CSI-RS overhead. The transmission spatial information may be used to train, select, and/or configure the machine learning module. The transmission spatial information described herein may facilitate machine learning at the UE, for example, due to a reduced frequency resource occupation associated with the number of CSI-RS ports represented by the transmission spatial information. The transmission spatial information described herein may facilitate flexible configurations at the network entity and/or UE, such as a flexible TxRU to antennal element mapping configuration at the network entity and/or a flexible machine learning configuration at the UE, as further described herein.

FIG. 5 is a diagram illustrating an example wireless communication network 500 using transmission spatial information, in accordance with certain aspects of the present disclosure. In this example, the BS 102 may transmit (e.g., send, output, or provide) (for example, to the UE 104) an indication of transmission spatial information 502, which may indicate the mapping of TxRUs to antenna elements of an antenna architecture associated with the BS 102, for example, as further described herein with respect to FIGS. 8-10. The UE 104 may monitor for downlink reference signals from the BS 102, such as a CSI-RS and/or SSB associated with beam(s) 504. The UE 104 may determine a channel estimation 506 and/or CSI 508 associated with the beams 504 based at least in part on the received reference signals corresponding to the beams 504 and the transmission spatial information 502. The UE 104 may report the CSI 508 to the BS 102. In some cases, the UE 104 may use the channel estimation 506 for transmit and/or receive beamforming, for example.

In certain cases, the BS 102 may transmit the reference signals (e.g., CSI-RS and/or SSB) using beams or via cover-codes, which may be obtained by machine learning and/or artificial intelligence (AI/ML) at the BS 102 and/or UE 104. The CSI-RS may be cross-node operation for AI/ML at the BS 102 and the UE 104. Under a cross-node operation, a beam or cover-code obtained by AI/ML may be used by the BS 102 to transmit the CSI-RS. The UE 104 may employ an AI/ML based channel estimation, where the AI/ML module at the BS 102 and the UE 104 may be matched, e.g., jointly trained. Similarly, CSI feedback may also be cross-node for AI/ML at the BS 102 and the UE 104. The UE 104 may use a CSI encoder to compress the channel estimate to a small dimension and report the CSI to the BS 102. The BS 102 may employ a CSI decoder to recover the full channel. In certain cases, the CSI encoder and decoder are matched AI/ML modules, e.g., jointly trained AI/ML modules.

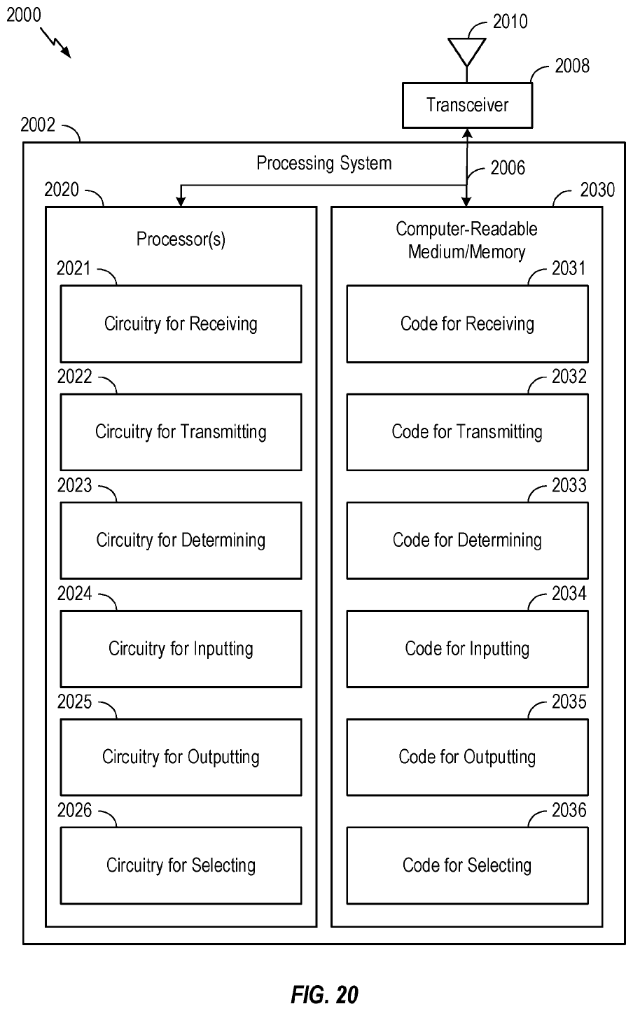

In certain cases, the UE 104 may perform artificial intelligence (e.g., a neural network and/or machine learning) and/or regression analysis (e.g., a linear minimum mean square error (LMMSE) operation) to determine the channel estimation 506 and/or the CSI 508. For example, the UE 104 may use a machine learning module 510 to determine the channel estimation 506 and/or the CSI 508. A processing system may perform the machine learning module 510, such as the processing system described herein with respect to FIG. 20. The input 512 of the machine learning module 510 may include measurements of the received reference signal(s) (e.g., a CSI-RS and/or SSB) from the BS 102. For example, the input 512 may include the received reference signal represented in the frequency domain. In certain aspects, the input 512 may be arranged in an input order 518, for example, based on a subcarrier index, a symbol index, and/or receive antenna index associated with the measurements. The output 514 of the machine learning module 510 may include the channel estimation 506 and/or the CSI 508. The machine learning module 510 may output the channel estimation 506 associated with each port of an antenna architecture in the frequency domain. In certain aspects, the frequency domain channel estimates may be arranged in an output order 520, for example, based on a port index, a resource block (RB) index, a subcarrier index (or a reference subcarrier index of each resource block), and/or a symbol index.

The machine learning module 510 may be trained in various ways. In certain cases, the network entity (e.g., the BS 102) may provide the UE 104 with training data to train the machine learning module 510. In some cases, the network entity (e.g., the BS 102) may transmit a certain reference signal to train the machine learning module 510 at the UE 104. In certain cases, the machine learning module 510 may be pre-trained to process the channel estimation 506 and/or the CSI 508.

In accordance with one or more examples, the transmission spatial information 502 may indicate a mapping 516 of TxRUs 522 (e.g., CSI-RS ports) to antenna elements 524 in an antenna architecture across a certain frequency bandwidth (e.g., a number or resource elements per resource block), for example, as further described herein with respect to FIGS. 8-10. The transmission spatial information 502 may indicate one or more cover-codes 526 (\tilde{X}) in the mapping 516. Each of the cover-codes 526 may be applied to a reference signal 528 (s) per resource element among a certain number of resource elements (RE0 through RE L−1) per TxRU 522 (e.g., CSI-RS port P). In certain aspects, the cover-codes 526 may indicate the beamforming applied to the reference signals, such as the amplitude and/or phase control, for a port. For example, the cover-codes associated with a resource block (RB) may provide that P ports map to L resource elements (RE) per resource block, where the number of resource elements L is less than the number of ports P. A cover-code of length L can be considered as a sequence of weights that map a certain transmission (e.g., TxRU) on L resource elements. In certain cases, the number of resource elements L may be much less than the number of ports P (L<<P), for example, where {P, L}={32, 8} or {128, 32}. In the example depicted, the number of ports (TxRUs) P may also be equal to Nt. In some cases, the number of cover-codes 516 may be reflected as P×L (=N_CSI-RS), where each row (\tilde{X}) applied to the reference signals(s) across the resource elements (RE0 through RE L−1) may correspond to a cover-code associated with a certain port P. The mapping to physical resources can be generalized to (P×L) N_CSI-RS RBs, where the cover-code(s) on each RB may have the same mapping or have a different mapping of ports to frequency resources.

In certain aspects, the UE may perform a channel estimation, which estimates the channel between the UE and the BS on P ports across N resource blocks, where the number of resource blocks N may be greater than or equal to the number resource blocks where CSI-RS is transmitted (N≥N_CSI-RS), using the input of CSI-RSs with a size reflected as L×N_CSI-RS.

In a model-based algorithm (e.g., LMMSE), the UE may be configured with the transmission spatial information (e.g., mapping of TxRUs to frequency resources) and/or cover-codes (e.g., beamforming) to determine the channel estimation. For example, the channel estimation may be determined using a LMMSE according to the following:

$$\hat{H} = {W}_{LMMSE} \times y , \qquad ( 1 )$$

$$where y = H \times X \times s$$

$$For {N}_{R B} : \tilde{X} = [ {\tilde{X}}_{1} , {\tilde{X}}_{2} , … , {\tilde{X}}_{{N}_{RB}} ] ∈ {C}^{{N}_{t} \times {LN}_{RB}}$$

$$s = diag ( {s}_{1} , … , {s}_{{N}_{RB}} ) ∈ {C}^{{LN}_{RB} \times {LN}_{RB}}$$

$$a = \tilde{X} s , where a ∈ {C}^{{N}_{t} \times {LN}_{RB}}$$

where Ĥ is the channel matrix, W_{LMMSE} is the precoder matrix, y is the received signals, H is the wireless channel, X is the cover-code (e.g., beamforming), and s is the pilot (e.g., reference signal). In cases where L=P, the UE may perform channel estimation per port as P ports are multiplexed on P REs per RB in an orthogonal manner with the spatial correlation at the transmitter (e.g., the transmission spatial information 502).

In a data-driven operation (e.g., artificial intelligence or machine learning), a machine learning module (e.g., the machine learning module 510) and/or a neural network may be used to determine the channel estimation, and another machine learning module or neural network may be used to determine the cover-code. The two machine learning modules and/or neural networks may be matched or trained jointly. The machine learning module may be trained to adapt to the spatial correlation (e.g., the transmission spatial information 502) of the training channel samples. The spatial correlation at the transmitter may be implicitly or explicitly indicated to the UE.

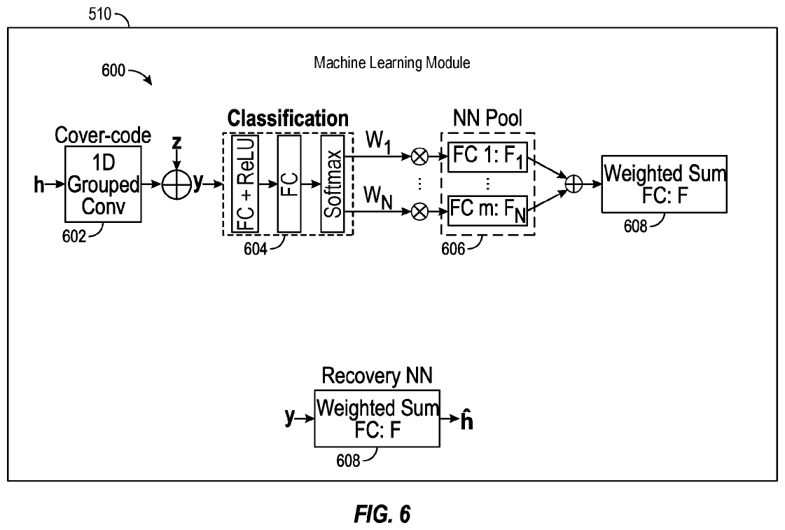

FIG. 6 is a diagram illustrating an example artificial intelligence architecture, for example, using a neural network 600 to determine a channel estimation. The neural network 600 may be an example of a machine learning module (e.g., the machine learning module 510) used at the UE to determine a channel estimation. As shown, the neural network 600 may take as input received signals y, which may be modeled as a function of channel information h (e.g., a channel matrix), transmitted signals z, and a cover-code model 602. The neural network 600 may use various operation layers during classification 604, such as a rectified linear unit (RecLU), a fully connected (FC) neural network, and a softmax layer. The neural network 600 may apply weights (w₁, . . . , w_{N}) to the neural network pool 606 to generate a FC neural network 608, which may be a weighted sum of the neural network pool 606. The neural network 600 may use the FC neural 608 to determine a channel estimation (ĥ) based on the received signals (y) as inputs. In some cases, the cover-code model 602 and neural network channel estimator (e.g., the neural network 600) may be trained jointly and/or adapted to the spatial correlation of the training channel samples implicitly or explicitly. In some cases, the machine learning module 510 may include the neural network 600.

In certain aspects, the spatial correlation at the transmitter may be used for artificial intelligence-based CSI feedback. In certain cases, the spatial correlation at the transmitter may be used to compress the channel and/or precoder in CSI feedback. An artificial intelligence module may be used for joint CSI-RS channel estimation and CSI-feedback design. For example, an artificial intelligence (e.g., a neural network) at the UE may take the received signal (e.g., CSI-RS) as input, and the artificial intelligence at the UE may output a bit sequence, which may indicate compressed estimation of the channel to the BS. In certain cases, the CSI-RS channel estimation the CSI feedback are designed separately for artificial intelligence and/or machine learning. In such cases, the input to the CSI encoder may be the channel estimate output (rather than the received signal), and the CSI encoder may output the channel or precoder. The BS may use artificial intelligence (e.g., a neural network) to translate (e.g., decode) the bit-sequence to channel state information. Artificial intelligence (e.g., neural network) may be used for applying the CSI-RS cover-code and/or beamforming at the BS. Artificial intelligence may be used at the UE for channel estimation and/or CSI encoding. Artificial intelligence may be used at the BS for CSI decoding. The artificial intelligence may be trained to adapt to the spatial correlation of the training samples.

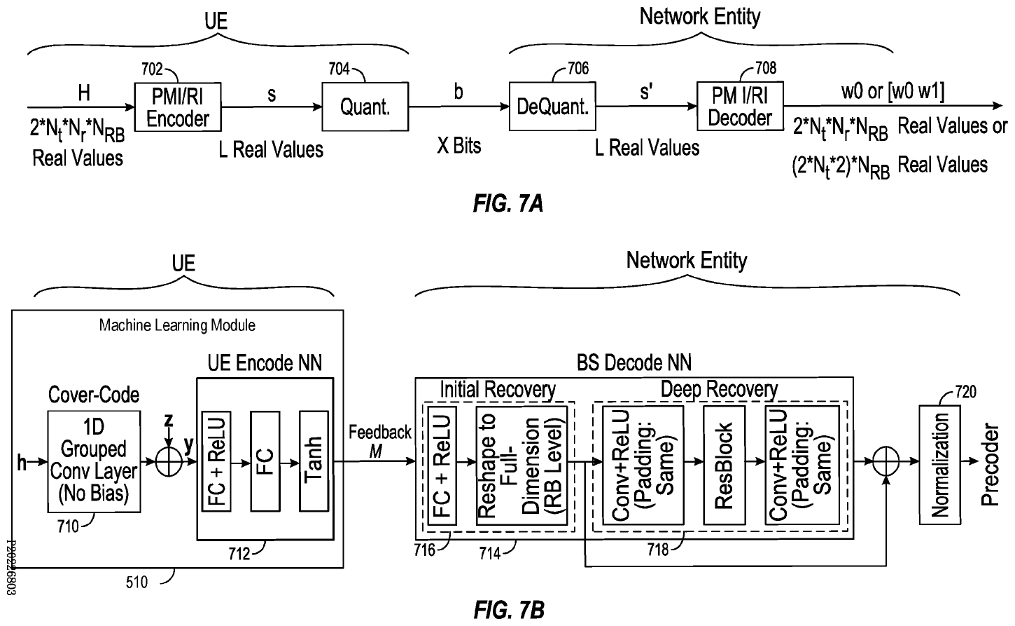

FIG. 7A is a diagram illustrating an example CSI feedback operation across the UE and BS. In this example, at the UE, the precoding matrix indicator (PMI) and/or rank indicator (RI) encoder 702 may take as a channel estimation (H), which may include a complex matrix (Nt*Nr) on each RB (N_{RB}). The channel estimation may be determined based on received CSI-RSs and/or other reference signals. The PMI/RI encoder 702 may output L values of CSI feedback(s), which may be quantized by a quantizer 704 to X bits. The UE may transmit the quantized X bits (b) to the BS, which may convert the quantized bits (b) to the CSI feedback (s′) with a dequantizer 706. A PMI/RI decoder 708 may decode the CSI feedback s′ into a precoder w (w0 for a rank of 1 and [w0, w1] for a rank of 2).

FIG. 7B is a diagram illustrating an example artificial intelligence architecture, for example, using a neural network to encode CSI at the UE and a neural network at the BS to decode the CSI into a precoder. In this example, a neural network CSI encoder 712 may take as input received signals y, which may be modeled as a function of channel information h (e.g., a channel matrix), transmitted signals z, and a cover-code model 710. The neural network CSI encoder 712 may be an example of a machine learning module (e.g., the machine learning module 510) used at the UE to generate CSI. In some cases, the machine learning module 510 may include the neural network CSI encoder 712. The neural network 712 may use various operation layers to encode the CSI feedback (M), such as a RecLU layer, a FC neural network, and a hyperbolic tangent activation function (tan h) layer. The UE may transmit the CSI feedback (M) to the BS, which may decode the CSI feedback into a precoder. The BS may use an artificial intelligence (AI) module 714 to recover the precoder. The AI module 714 may have an initial recovery module 716, which may include, for example, a RecLU layer, an FC neural network layer, and reshaping layer. The initial recovery module 716 may take as input the CSI feedback received from the UE. The reshaping layer may reshape the processed CSI feedback to a full dimension at the resource block level. The AI module 714 may also have a deep recovery module 718, which may take as input the output from the initial recovery module 716. The deep recovery module 718 may include, for example, a convolution layer, a RecLU layer, and/or a resource block (ResBlock) layer. The output from the initial recovery module 716 may be added or combined with the output from the deep recovery module 718. The combined output may be normalized with a normalization module 720, which may recover the precoder.

FIG. 8 is a diagram illustrating an example spatial correlation (e.g., transmission spatial relationship) for an antenna architecture having eight by eight cross-polarized antenna elements. The antenna architecture may have an antenna array 802 including cross-polarized antenna element pairs 804a, 804b (collectively 804), where the antenna pairs 804 are arranged in eight columns (N=8) across eight rows (M=8). Each of the cross-polarized antenna pairs 804 may include a vertical antenna element 804a and a horizontal antennal element 804b. A TxRU 806 may map to a set 808 of four vertical antenna elements 804a in the antenna array 802. For example, the set 808 of four vertical antenna elements 804a may be arranged in the same column of the antenna array 802 and arranged in a sequence of adjacent antenna elements. The TxRU 806 may have a cover-code/beamformer 810 associated with L resource elements (RE0-RE L−1). The other TxRUs may follow the same mapping to four antenna elements, where every four antenna elements 804 along a column of the antenna array 802 may be mapped to a TxRU. The other TxRUs may be mapped to the antenna elements 804 in the vertical and horizontal polarization dimensions. The TxRU to antenna element mapping may result in two TxRUs being mapped per column of the antenna array per polarization dimension (e.g., vertical and horizontal). The number of TxRUs may be given by N1*N2*P_{dim}, where N1 is the number of TxRUs (e.g., N1=2), N2 is the number columns in the antenna array (e.g., N2=8), and P_{dim} is the polarization dimension (e.g., P_{dim}=2), in this example. In certain cases, an analog beamforming layer 812 may be associated with each of the antenna elements 804. In some cases, the cover-code/beamformer 810 at the BS and an artificial intelligence module 816 for channel estimation and/or CSI feedback at the UE may be jointly trained to correspond with the antenna architecture of eight by eight cross-polarized antenna elements.

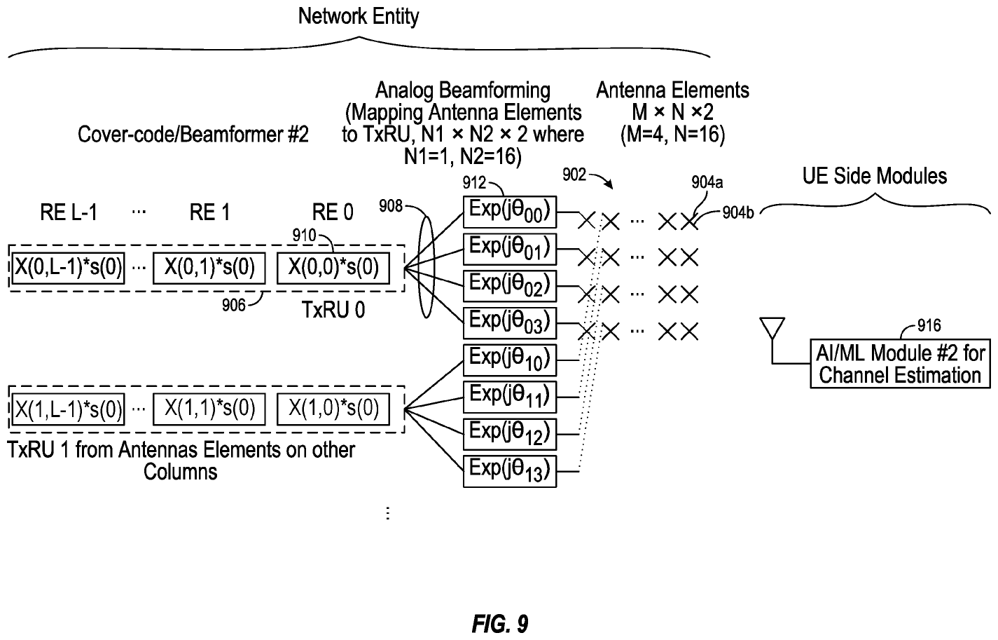

FIG. 9 is a diagram illustrating an example spatial correlation for an antenna architecture having four by sixteen cross-polarized antenna elements. In this example, the antenna array 902 may have antenna pairs 904 arranged in a sixteen columns (N=16) across four rows (M=4). The TxRU 906 may map to a set 908 of four vertical antenna elements 904a in the antenna array 902. The set 908 of four vertical antenna elements 904a may be arranged in the same column of the antenna array 902 and arranged in a sequence of adjacent antenna elements 904a. The TxRU 906 may have a cover-code/beamformer 910 associated with L resource elements (RE0-RE L−1). The other TxRUs may follow the same mapping to four antenna elements, where every four antenna elements 904 along a column of the antenna array 902 may be mapped to a TxRU. The TxRU to antenna element mapping may result in a single TxRU being mapped per column of the antenna array per polarization dimension. The number of TxRUs may be given by N1*N2*P_{dim}, where N1=1, N2=16, and P_{dim}=2, in this example. The analog beamforming layer 912 may be associated with each of the antenna elements 904. The cover-code/beamformer 910 at the BS and an artificial intelligence module 916 for channel estimation and/or CSI feedback at the UE may be jointly trained to correspond with the antenna architecture of four by sixteen cross-polarized antenna elements.

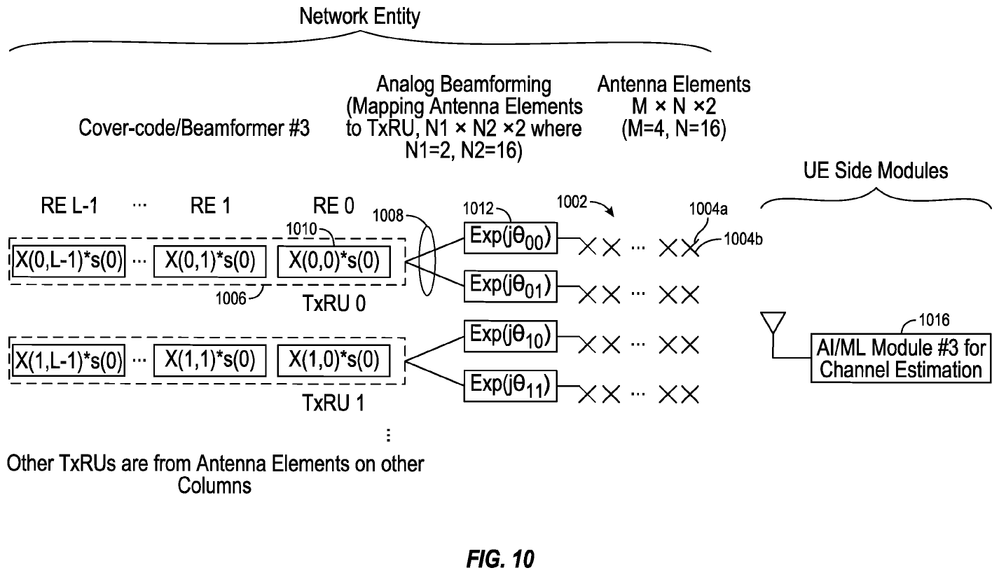

FIG. 10 is a diagram illustrating another example spatial correlation for an antenna architecture having four by sixteen cross-polarized antenna elements. In this example, the antenna array 1002 may have antenna pairs 1004 arranged in a sixteen columns (N=16) across four rows (M=4). The TxRU 1006 may map to a set 1008 of two vertical antenna elements 1004a. The set 1008 of two vertical antenna elements 1004a may be arranged in the same column of the antenna array 1002 and arranged in a sequence of adjacent antenna elements 1004a. The TxRU 1006 may have a cover-code/beamformer 1010 associated with L resource elements (RE0-REL−1). The other TxRUs may follow the same mapping to two antenna elements, where every two antenna elements 1004 along a column of the antenna array 1002 may be mapped to a TxRU. The TxRU to antenna element mapping may result in two TxRUs being mapped per column of the antenna array per polarization dimension. The number of TxRUs may be given by N1*N2*P_{dim}, where N1=2, N2=16, and P_{dim}=2, in this example. The analog beamforming layer 1012 may be associated with each of the antenna elements 1004. The cover-code/beamformer 1010 at the BS and an artificial intelligence module 1016 for channel estimation and/or CSI feedback at the UE may be jointly trained to correspond with the antenna architecture of four by sixteen cross-polarized antenna elements.

While the examples depicted in FIGS. 8-10 are described herein with respect to TxRU mapping associated with analog beamforming to facilitate understanding, aspects of the present disclosure may also be applied to TxRU mapping associated with digital beamforming and/or hybrid beamforming (e.g., a combination of analog and digital beamforming). Each of the artificial intelligence modules 816, 916, 1016 may be representative of the machine learning module 510.

In certain aspects, the transmission spatial information may be indicated (implicitly) via a cover-code configuration. A UE may be configured with one or more cover-code configurations, such as the TxRU mappings described herein with respect to FIGS. 8-10. Each cover code configuration may identify a cover-code (e.g., the cover-code 526 or cover-code/beamformer 810), a corresponding antenna architecture (e.g., the antenna array 802), and/or a corresponding machine learning module (e.g., the artificial intelligence module 816) to be applied at the UE. The cover-code configuration may identify a TxRU mapping, such as the TxRU mapping described herein with respect to FIG. 8. Each of the cover-code configurations may be associated with a particular index or identifier.

The cover-code configurations may be associated with a certain number of antenna architectures supported by wireless communication networks. The cover-code configuration may facilitate flexible configuration/implementation of the artificial intelligence and/or machine learning used for channel estimation and/or CSI at the UE. The cover-code configuration may also facilitate flexible configuration/implementation of the channel estimation performed for each of the antenna architectures and corresponding cover-codes.

In certain aspects, the antenna architecture at the BS may be indicated via a CSI-RS port grouping. Each cover-code configuration may be linked to a particular layout of an antenna architecture, such as the antenna architectures described herein with respect to FIGS. 8-10. An antenna architecture may include N1 columns and N2 rows of antenna elements corresponding to CSI-RS port grouping. Assuming an antenna architecture with cross-polarization, the total number of ports (Nt) may be determined according to the following expression: Nt=P_{dim}*N1*N2 ports, as described herein with respect to FIGS. 8-10. The first half of the ports (e.g., the vertical polarization) may be divided into N1 groups with N2 ports, and the same may be arranged for the second half of the ports (e.g., the horizontal polarization). For each cover-code configuration, the cover-code may be designed for CSI-RS ports having N1 groups, where each of the groups has N2 ports. N1 may correspond to the number of TxRUs per column, and N2 may correspond to the number of columns of the antenna architecture. In some cases, the N1 groups may correspond to the number of columns of the antenna architecture after bundling, and N2 ports may correspond to the number of rows in the antenna architecture, for example.

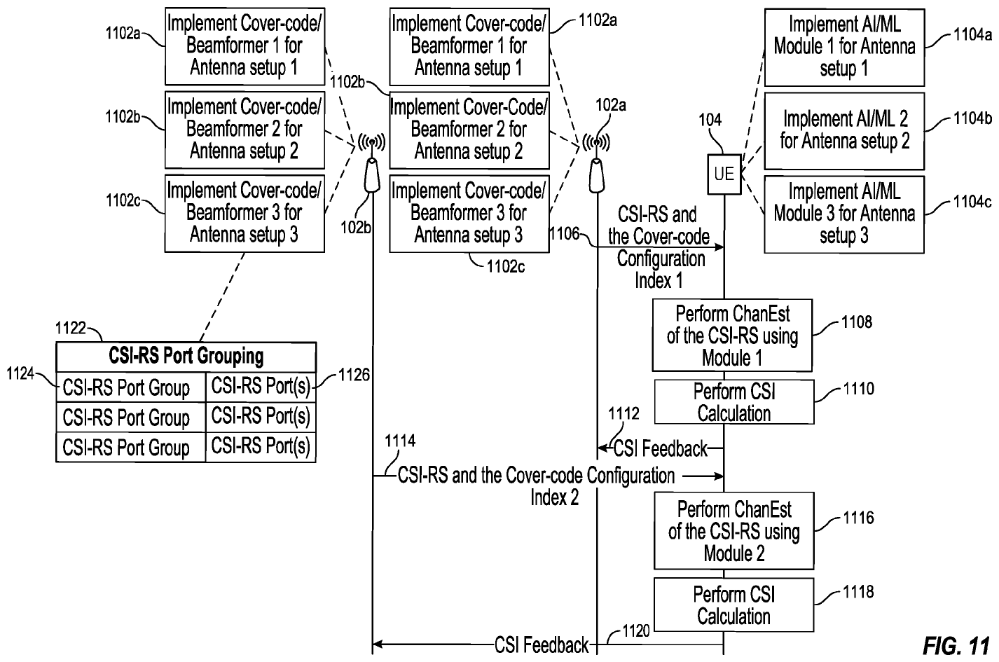

FIG. 11 is a signaling flow diagram illustrating an example of indicating transmission spatial information via a cover-code configuration. In this example, the BSs 102a, 102b may be configured with certain spatial correlations for one or more antenna architectures 1102a-c, such as the spatial correlations described herein with respect to FIGS. 8-10. The UE 104 may also be configured with certain machine learning modules 1104a-c associated with each of the antenna architectures 1102a-c. For example, the antenna architecture 1102a may be representative of the antenna architecture described herein with respect to FIG. 8, and the machine learning module 1104a may be representative of the artificial intelligence module 1016. In certain cases, the antenna architecture may be represented according to a CSI-RS port grouping 1122. CSI-RS ports may be arranged in groups, for example, as described herein with respect to N1 groups, where each group has N2 ports. For example, a CSI-RS resource group 1124 may be associated with one or more CSI-RS ports(s) 1126, which may be representative of certain antenna elements. The CSI-RS port(s) 1126 may be representative of the antenna elements mapped to a particular TxRU, such as TxRU 806 mapping to a set of antenna elements 804a.

At activity 1106, the UE 104 may receive, from the first BS 102a, an indication of a first cover-code configuration associated with the first antenna architecture 1002a, such as a cover-code configuration index or identifier. The first cover-code configuration may identify the transmission spatial information used at the first BS 102a. The UE 104 may be configured with a relationship between the first machine learning module 1104a and the first antenna architecture 1102a. The first cover-code configuration may indicate to the UE 104 to use the first machine learning module 1104a for channel estimation and/or CSI. In some cases, the first machine learning module 1104a may be a joint machine learning module for channel estimation and CSI feedback. In certain cases, the first machine learning module 1104a may be representative of a machine learning module for channel estimation and another machine learning module for CSI feedback. In certain cases, the first machine learning module 1104a may be representative of a machine learning module for CSI feedback which takes channel estimation results as input wherein the channel estimation may be performed using AI or non-AI modules. There can be multiple AI/ML modules for CSI feedback and/or channel estimation, and the indication of the first cover-code configuration may indicate which AI/ML to use for CSI feedback and/or channel estimation. The UE 104 may also receive, from the first BS 102a, one or more CSI-RSs associated with the first cover-code configuration. For example, the first BS 102a may transmit a CSI-RS using the TxRU to antenna element mapping described herein with respect to FIG. 8.

At activity 1108, the UE 104 may perform channel estimation of the CSI-RS(s) received from the first BS 102a using the first machine learning module 1104a associated with the first antenna architecture 1102a.

At activity 1110, the UE 104 may perform CSI calculation(s), for example, based on the channel estimation performed at activity 1108 and/or the received CSI-RS(s). For example, the UE 104 may determine a channel quality indicator (CQI), a precoding matrix indicator (PMI), a reference signal received power (RSRP), and/or signal-to-interference plus noise ratio (SINR) associated with the CSI-RS. In certain cases, the UE 104 may generate the CSI using the first machine learning module 1104a.

At activity 1112, the UE 104 may transmit, to the first BS 102a, the CSI based on the CSI-RS(s) and the corresponding first cover-code configuration.

At activity 1114, the UE 104 may receive, from the second BS 102b, an indication of a second cover-code configuration associated with the second antenna architecture 1002b, such as a cover-code configuration index or identifier. The second cover-code configuration may identify the transmission spatial information used at the second BS 102b. The UE 104 may be configured with a relationship between the second machine learning module 1104b and the second antenna architecture 1102b. The second cover-code configuration may indicate to the UE 104 to use the first machine learning module 1104a for channel estimation and/or CSI. The UE 104 may also receive, from the first BS 102a, one or more CSI-RSs associated with the cover-code configuration.

At activity 1116, the UE 104 may perform channel estimation of the CSI-RS(s) received from the second BS 102b, for example, using the second machine learning module 1104b associated with the second antenna architecture 1102b. At activity 1118, the UE 104 may determine the CSI associated with the CSI-Rs(s) received from the second BS 102b, for example, using the second machine learning module 1104b. At activity 1120, the UE 104 may transmit, to the second BS 102b, the CSI based on the CSI-RS(s) and the corresponding second cover-code configuration.

In certain aspects, the transmission spatial information may be indicated via a machine learning module associated with a cover-code, which may be indicative of the transmission spatial information. The machine learning module may be representative of an artificial intelligence module and/or a neural network module. In some cases, the UE may receive, from the network entity, a list of neural network and/or machine learning modules for channel estimation and/or CSI. For example, the network entity may configure the UE with the list of neural network and/or machine learning via control signaling, such as radio resource control (RRC) signaling, downlink control information (DCI), medium access control (MAC) signaling, and/or system information, or upper-layer information carried on a physical downlink shared channel (PDSCH). The network entity may indicate to the UE which of the neural network and/or machine learning modules to use for channel estimation and/or CSI based on an indication of a CSI-RS cover-code configuration index via DCI and/or MAC signaling, for example. In aspects, there may be a one-to-one mapping between each of the machine learning modules and a specific cover-code configuration. The UE may apply the corresponding machine learning module for channel estimation and/or CSI in response to receiving an indication of the cover-code configuration.

The machine learning module indication may enable a flexible implementation at the base station. Each base station may have freedom to determine the antenna element-to-TxRU mapping associated with a specific antenna architecture. The corresponding cover-code, artificial intelligence, and/or machine learning implemented at the UE may be determined according to the TxRU mapping. The network entity may support a certain number of artificial intelligence and/or machine learning modules as well as specific types of artificial intelligence and/or machine learning modules used at the UE.

In certain aspects, the artificial intelligence and/or machine learning modules at the UE may support a specific format for input and/or output. The input of the machine learning module may include the frequency domain received signal, such as a CSI-RS in the frequency domain. The received signal may be input to a machine learning module in specific order, such as in increasing order of subcarrier index (first), and increasing order of OFDM symbol index (second), and receive antenna index (third).

The output of the machine learning may include a frequency domain channel estimate for each port (e.g., CSI-RS port). In certain cases, the output of machine learning module may be arranged in a specific order, such as in an increasing order of port index (first), and in the increasing order of subcarrier index (second), and in the increasing order of OFDM symbol index (third). In some cases, the order can be in an increasing order of subcarrier index (first), and in the increasing order of OFDM symbol index (second), and in the increasing order of port index (third). In such cases, for each port, the respective channel estimate may be based on a subset of subcarriers and OFDM symbols in each RB, and the subset may be the same subcarriers/OFDM symbols as the received signal. In some cases, the output of the machine learning module may be arranged in a specific order, such as in the increasing order of port index (first), and RB index (second). In such cases, for each port, the respective channel estimate may be based on a reference subcarrier of each RB, where the reference subcarrier index may be defined in a wireless communications standard, such as 3GPP standards for 5G NR.

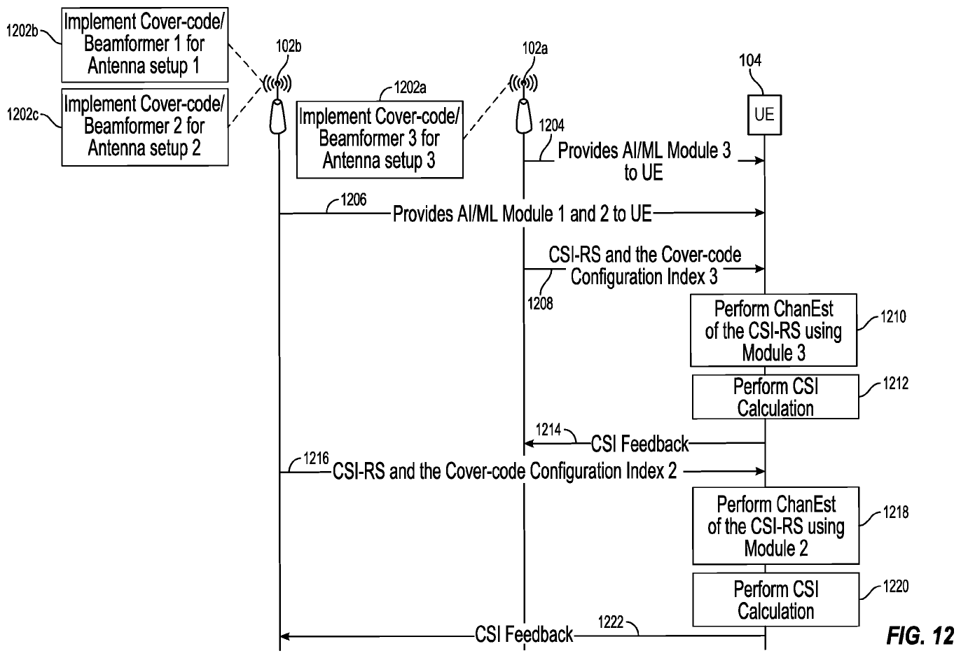

FIG. 12 is a signaling flow diagram illustrating an example of indicating transmission spatial information via a machine learning module associated with a cover-code. In this example, the first BS 102a may support a first spatial correlation associated with a first antenna architecture 1202a, and the second BS 102b may support second and third spatial correlations associated with the respective antenna architectures 1202b, 1202c, for example, as described herein with respect to FIGS. 8-10.

At activity 1204, the UE 104 may receive, from the first BS 102a, an indication identifying the machine learning module(s) supported by the first BS 102a. In this example, the first BS 102a indicates that machine learning module 3 is supported for the first antenna architecture 1202a. In certain cases, the indication may include a list of the machine learning modules supported by the first BS 102a. The indication may be provided via RRC signaling, for example.

At activity 1206, the UE 104 may receive, from the second BS 102b, an indication identifying that the second BS 102b supports machine learning modules 1 and 2 for antenna architectures 1202b, 1202c, respectively.

At activity 1208, the UE 104 may receive, from the first BS 102a, an indication to use a specific cover-code associated with the machine learning module 3. For example, the UE 104 may receive an indication of a cover-code configuration associated with the machine learning module 3. The indication to use a specific cover-code may be received via DCI and/or MAC signaling, for example. The UE 104 may also receive, from the first BS 102a, the CSI-RS(s) based on the cover-code. As described herein, the indication of the cover-code may indicate which AI/ML module to use for channel estimation and/or CSI feedback, where the AI/ML module may be jointly or separately designed for channel estimation and/or CSI feedback. In some cases, the indication of the cover-code may indicate which AI/ML module to use for CSI feedback.

At activity 1210, the UE 104 may perform channel estimation of the CSI-RS(s) received from the first BS 102a using the machine learning module 3 associated with the first antenna architecture 1202a, for example, based on the channel estimation and/or the received CSI-RS(s). At activity 1212, the UE 104 may generate CSI using the machine learning module 3 associated with the first antenna architecture 1202a. At activity 1214, the UE 104 may transmit, to the first BS 102a, the CSI based on the CSI-RS(s).

At activity 1216, the UE 104 may receive, from the second BS 102b, an indication to use a specific cover-code associated with the machine learning module 2. The UE 104 may also receive, from the second BS 102b, the CSI-RS(s) based on the cover-code. At activity 1218, the UE 104 may perform channel estimation of the CSI-RS(s) received from the second BS 102b using the machine learning module 2 associated with the second antenna architecture 1202b. At activity 1220, the UE 104 may generate CSI using the machine learning module 2 associated with the second antenna architecture 1202b. At activity 1222, the UE 104 may transmit, to the second BS 102a, the CSI based on the CSI-RS(s).

In certain aspects, the transmission spatial information may be indicated via a quasi-colocation (QCL) information, such as a QCL type and/or a QCL reference signal. The QCL type may be a separate type associated with a transmit spatial relationship and/or parameter, such as the QCL-TypeE as further described herein. The QCL information may be indicated via a tracking reference signal (TRS) and/or a QCL reference signal associated with the QCL type for transmission spatial information. The QCL information may indicate that the target signal and/or channel have a QCL relationship with the TRS and/or QCL reference signal based on the QCL type. The QCL reference signal for transmission spatial information may include an SSB, a TRS, CSI-RS, a separate RS associated with conveying the transmission spatial information and/or synthesis training data. The target signal and/or channel may be considered quasi collocated with a specific TRS/CSI-RS or synthesis training data associated with the transmission spatial information. The QCL reference signal (e.g., a TRS) may have more than one port (for example, as described herein with respect to the antenna architectures), a narrow band (e.g., 1 RB to 24 RBs), and/or a long periodicity (e.g., >640 slots). In certain aspects, the QCL reference signal for transmission spatial information may not be associated with any CSI reporting. For example, a CSI report setting may identify the report quantity for the QCL reference signal as none.

The UE may receive a QCL configuration identifying a QCL type associated with a transmit spatial relationship or parameter. The UE may perform channel estimation based on the QCL information for transmission spatial information. The UE may apply a spatial tracking loop to the QCL reference signal. For non-artificial-intelligence-based techniques, the UE may obtain spatial correlation among ports, and use the spatial correlation for port extrapolation.

For artificial intelligence-based techniques, the UE may be configured with multiple neural network modules for channel estimation and select at least one of the neural network modules based on the measured transmit spatial relationship associated with the corresponding QCL reference signal. In some cases, the UE may be configured with a neural network module for channel estimation and take the transmit spatial relationship as input for the neural network module.

QCL information and/or types may in some scenarios depend on or be a function of other information. In accordance with one or more examples, the QCL types indicated to the UE may be based on higher layer parameter QCL-Type and may take one or a combination of the following types:
QCL-TypeA: {Doppler shift, Doppler spread, average delay, delay spread},
QCL-TypeB: {Doppler shift, Doppler spread},
QCL-TypeC: {average delay, Doppler shift},
QCL-TypeD: {Spatial Receive (Rx) parameter}, or
QCL-TypeE: {Spatial Transmit (Tx) parameter or relationship}.

A QCL assumption may include a frequency dispersion assumption, a time dispersion assumption, and/or a spatial assumption. The frequency dispersion assumption may include Doppler shift and/or Doppler spread, and the time dispersion assumption may include average delay and/or delay spread. The spatial assumption (e.g., spatial Rx parameters for QCL-TypeD and/or Tx Spatial Relationship for QCL-TypeE) may be indicative of various spatial parameters for receive and/or transmit beamforming such as angle of arrival (AoA), AoA spread, dominant AoA, average AoA, angle spread of AoA, Power Angular Spectrum (PAS) of AoA, angle of departure (AoD), AoD spread, average AoD, angle spread of AoD, PAS of AoD, a zenith angle of arrival (ZoA), ZoA spread, dominant ZoA, average ZoA, angle spread of ZoA, Power Angular Spectrum (PAS) of a zenith angle of departure (ZoD), ZoD spread, dominate ZoD, average ZoD, angle spread of ZoD, PAS of ZoD, transmit/receive channel correlation, transmit/receive beamforming, spatial channel correlation, etc. The spatial QCL assumptions may enable a UE to determine a spatial filter (analog, digital, or hybrid) for beamforming a receive beam (e.g., during beam management procedures) and/or a transmit beam. For example, an SSB resource indicator may indicate that the AoA spread for a previous reference signal (e.g., the SSB) may be used for a subsequent transmission (e.g., a PDSCH transmission).

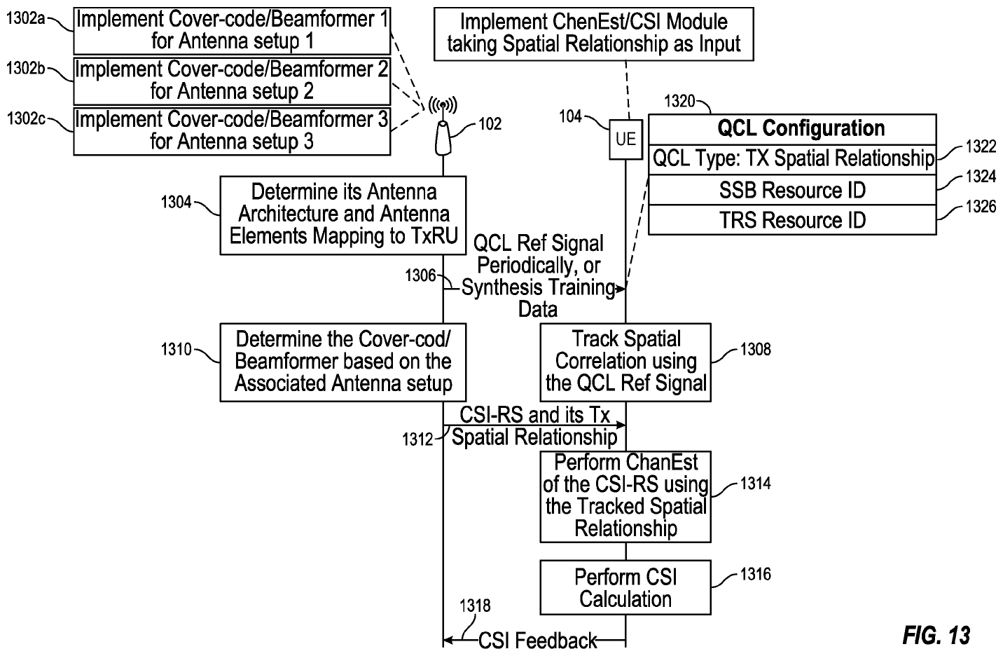

FIG. 13 is a signaling flow diagram illustrating an example of indicating transmission spatial information via QCL information. In this example, the BS 102 may support a spatial correlation associated with each of the antenna architectures 1302a-c, for example, as described herein with respect to FIGS. 8-10. In some cases, the UE 104 may be configured to perform channel estimation and/or generate CSI taking the transmission spatial information derived from a QCL reference signal as input. In certain cases, the UE 104 may apply a binning-based approach, where there are N trained machine learning modules (or neural networks), and each of the machine learning modules is associated with a range of transmission information statistics. The UE 104 may determine which of the machine learning modules to use for channel estimation and/or CSI feedback based on the measured transmission spatial information derived from a QCL reference signal.

At activity 1304, the BS 102 may select to use a specific spatial correlation associated with one of the antenna architectures 1302a-c. For example, the BS 102 may select the first antenna architecture 1302a and a corresponding TxRU mapping, such as the architecture and mapping described herein with respect to FIG. 8.

At activity 1306, the UE 104 may receive, from the BS 102, a QCL configuration 1320 indicating QCL information associated with transmission spatial information. For example, the configuration may identify one or more QCL reference signals having a QCL type 1322 associated with a transmit spatial relationship or parameter. In some cases, the QCL reference signals may be indicated via reference signal resource identifiers (IDs), such as an SSB resource ID 1324 and/or a TRS resource ID 1326. The configuration 1320 may identify that the SSB associated with the SSB resource ID 1324 has a QCL relationship with the TRS associated with the TRS resource ID 1326. The UE 104 may also receive, from the BS 102, the QCL reference signal (e.g., the TRS), where the QCL reference signal may be indicative of training data for a machine learning module. The QCL reference signal may be a periodic reference signal, semi-persistent reference signal, and/or an aperiodic reference signal.

At activity 1308, the UE 104 may determine the transmission spatial information based on a spatial tracking loop of the QCL reference signal. The UE 104 may perform an estimation of the spatial information using measurements of the QCL reference signal. In some cases, the UE 104 may train a machine learning module based on measurements of the QCL reference signal, which may be indicative of the transmission spatial information.

At activity 1310, the BS 102 may select the cover-code/beamformer based on the associated first antenna architecture 1302a.

At activity 1312, the UE 104 may receive a CSI-RS from the BS 102 based on the transmission spatial information derived at activity 1318. At activity 1314, the UE 104 may perform channel estimation of the CSI-RS(s) received from the BS 102 using the transmit spatial information derived from the QCL reference signal at activity 1308. For example, the UE 104 may perform channel estimation using the machine learning module trained based on the QCL reference signal. At activity 1316, the UE 104 may generate the CSI using the transmit spatial information derived from the QCL reference signal at activity 1308. For example, the UE 104 may generate the CSI using the machine learning module trained based on the QCL reference signal. At activity 1318, the UE 104 may transmit, to the BS 102, the CSI based on the CSI-RS(s) and the corresponding transmission spatial information.

For certain aspects, the transmission spatial information may be indicated via an in-distribution configuration. The in-distribution configuration may indicate that a target signal or channel may be conveyed in the same distribution as a synthesis signal or channel. A target signal or channel may have the same distribution with a synthesis training data channel sample for a machine learning and/or artificial intelligence module. The network entity may output synthesis data (for example, to the UE), and the UE may perform online training of the machine learning module using the synthesis data. The UE may apply the trained machine learning module to certain signals and/or channels received from the network entity. There may be multiple online training procedures triggered by the network entity (such as by a first base station and a second base station) with training data for each of the machine learning modules. For example, the UE may perform training for a first machine learning module associated with a first base station (or antenna architecture) and for a second machine learning module associated with a second base station (or antenna architecture). The in-distribution may indicate which machine learning module to apply.

In certain aspects, the artificial intelligence and/or machine learning modules at the UE may support a specific format for input and/or output. The machine learning module may take as input a frequency domain received signal. The received signal and synthesis data may be input to the machine learning module in an increasing order of subcarrier index (first), and increasing order of OFDM symbol index (second), and receive antenna index (third) for example.

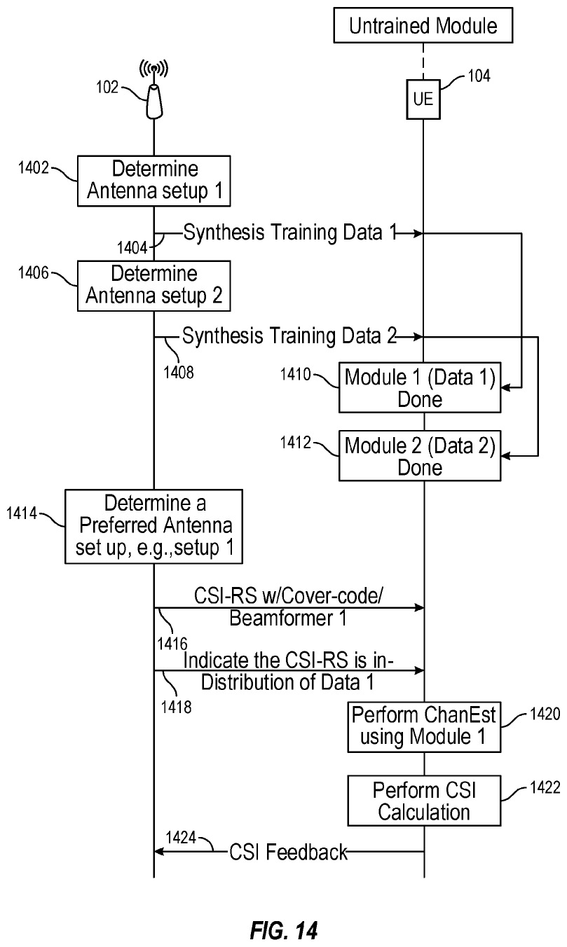

FIG. 14 is a signaling flow diagram illustrating an example of indicating transmission spatial information via an in-distribution configuration for machine learning modules associated with a base station. At activity 1402, the BS 102 may determine a spatial correlation associated with a first antenna architecture and/or TxRU mapping, for example, as described herein with respect to FIGS. 8-10. At activity 1404, the UE 104 may receive, from the BS 102, synthesized training data associated with the first antenna architecture. At activity 1406, the BS 102 may determine a spatial correlation associated with a second antenna architecture and/or TxRU mapping, for example, as described herein with respect to FIGS. 8-10. At activity 1408, the UE 104 may receive, from the BS 102, synthesized training data associated with the second antenna architecture. At activity 1410, the UE 104 may train a first machine learning module based on the training data associated with the first antenna architecture of the BS 102. At activity 1412, the UE 104 may train a second machine learning module based on the training data associated with the second antenna architecture of the BS 102.

At activity 1414, the BS 102 may select the first antenna architecture to use for communications with the UE 104. At activity 1416, the UE 104 may receive, from the BS 102, a CSI-RS, where the BS 102 may use the cover-code/beamformer associated with the first antenna architecture to transmit the CSI-RS. At activity 1418, the UE 104 may receive an indication that the CSI-RS is in-distribution with the training data associated with the first antenna architecture. The indication may trigger the UE 104 to use the first machine learning module for channel estimation and/or CSI feedback. As described herein, the indication of the in-distribution with the training data may indicate which AI/ML module to use for channel estimation and/or CSI feedback, where the AI/ML module may be jointly or separately designed for channel estimation and/or CSI feedback. In some cases described herein, the indication of the in-distribution with the training data may indicate which AI/ML module to use for CSI feedback, where the AI/ML module for CSI feedback may take the channel estimation results as input wherein the channel estimation results may be produced via AI or non-AI methods. At activity 1420, the UE 104 may perform channel estimation of the CSI-RS(s) received from the BS 102 using the first machine learning module trained at activity 1410. At activity 1422, the UE 104 may generate the CSI using the first machine learning module trained at activity 1410, for example, based on the channel estimation and/or the received CSI-RS(s) wherein the channel estimation results may be produced via AI or non-AI methods. At activity 1424, the UE 104 may transmit, to the BS 102, the CSI based on the CSI-RS(s) and the corresponding transmission spatial information.

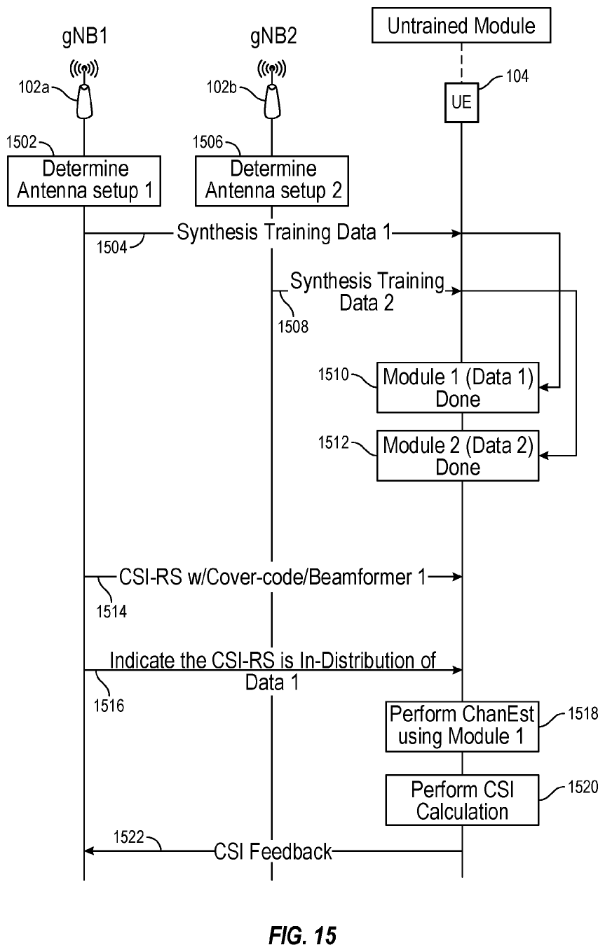

FIG. 15 is a signaling flow diagram illustrating another example of indicating transmission spatial information via an in-distribution configuration for machine learning modules associated with multiple base stations. At activity 1502, the first BS 102a may determine a spatial correlation associated with a first antenna architecture and/or TxRU mapping, for example, as described herein with respect to FIGS. 8-10. At activity 1504, the UE 104 may receive, from the first BS 102a, synthesized training data associated with the first antenna architecture. At activity 1506, the second BS 102b may determine a spatial correlation associated with a second antenna architecture and/or TxRU mapping, for example, as described herein with respect to FIGS. 8-10. At activity 1508, the UE 104 may receive, from the second BS 102b, synthesized training data associated with the second antenna architecture. At activity 1510, the UE 104 may train a first machine learning module based on the training data associated with the first antenna architecture of the first BS 102a. At activity 1512, the UE 104 may train a second machine learning module based on the training data associated with the second antenna architecture of the second BS 102b.

At activity 1514, the UE 104 may receive, from the first BS 102a, a CSI-RS, where the first BS 102a may use the cover-code/beamformer associated with the first antenna architecture to transmit the CSI-RS. At activity 1516, the UE 104 may receive, from the first BS 102a, an indication that the CSI-RS is in-distribution with the training data associated with the first antenna architecture. The indication may trigger the UE 104 to use the first machine learning module for channel estimation and/or CSI feedback. As described herein, the indication of the in-distribution with the training data may indicate which AL/ML module to use for channel estimation and/or CSI feedback, where the AI/ML module may be jointly or separately designed for channel estimation and/or CSI feedback. In some cases described herein, the indication of the in-distribution with the training data may indicate which AI/ML module to use for CSI feedback, where the AI/ML module for CSI feedback may take the channel estimation results as input. At activity 1518, the UE 104 may perform channel estimation of the CSI-RS(s) received from the first BS 102a using the first machine learning module trained at activity 1510. At activity 1520, the UE 104 may generate the CSI using the first machine learning module trained at activity 1510, for example, based on the channel estimation and/or the received CSI-RS(s), wherein the channel estimation may be produced via AI or non-AI methods. At activity 1522, the UE 104 may transmit, to the first BS 102a, the CSI based on the CSI-RS(s) and the corresponding transmission spatial information.

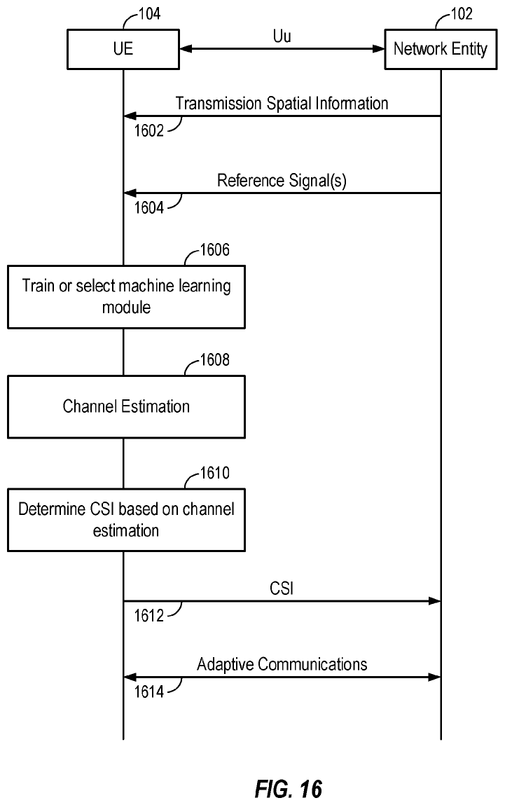

FIG. 16 is a signaling flow diagram illustrating an example of indicating transmission spatial information. At activity 1602, the UE 104 may receive, from the BS 102, an indication of transmission spatial information. The indication of the transmission spatial information may include an indication of a cover-code configuration, a machine learning module, QCL information, and/or an in-distribution configuration associated with the transmission spatial information, for example, as described herein with respect to FIGS. 11-15. The transmission spatial information may map P ports (e.g., TxRUs) to L resource elements in each resource block, where L is less than P. For example, the transmission spatial information may identify that P ports occupy L resources elements per resource block, for example, where {P, L}={32, 8} or {128, 32}. Such transmission spatial information may enable a UE to process the frequency bandwidth associated with the antenna architecture of the BS 102. In certain cases, the indication of the transmission spatial information may indicate which AI/ML module to use for channel estimation and/or CSI feedback, where the AI/ML module may be jointly or separately designed for channel estimation and/or CSI feedback. For example, the indication of the transmission spatial information may indicate which AI/ML module to use for determining the CSI feedback.

At activity 1604, the UE 104 may receive, from the BS 102, one or more reference signals associated with the transmission spatial information. The BS 102 may transmit the reference signals using the TxRU mapping associated with the antenna architecture, for example, as described herein with respect to FIGS. 8-10. In some cases, the reference signal(s) may include a QCL reference signal, for example, as described herein with respect to FIG. 13. In certain cases, the reference signal(s) may include an SSB, CSI-RS, TRS, or any combination thereof.

Optionally, at activity 1606, the UE 104 may train or select a machine learning module based on the transmission spatial information. In some cases, the indication of the transmission spatial information may identify a cover-code configuration associated with a specific machine learning module, such that the indication of the transmission spatial information triggers the UE 104 to select the machine learning module for channel estimation and/or CSI feedback. In certain cases, the indication of the transmission spatial information may identify QCL information and/or in-distribution configuration, which can be used to train the machine learning module based on a QCL reference signal and/or training data, respectively.

At activity 1608, the UE 104 may perform channel estimation of the channel between the UE 104 and the BS 102 based on the transmission spatial information and measurements of the reference signal(s). For example, the UE 104 may use the machine learning module selected/trained at activity 1606 to perform channel estimation.

At activity 1610, the UE 104 may determine CSI based on the channel estimation and/or the transmission spatial information. For example, the UE 104 may use the machine learning module selected/trained at activity 1606 to generate the CSI. In some cases, the UE 104 may use the machine learning module to generate the CSI based on the channel estimation and/or the received reference signal(s).

At activity 1612, the UE 104 may transmit, to the BS 102, the CSI based on the transmission spatial information and/or received reference signal(s). For example, the CSI may indicate a CQI, a PMI, a RSRP, and/or SINR associated with the reference signal(s).

At activity 1614, the UE 104 may communicate with the BS 102 based on the CSI. For example, the BS 102 may adjust the modulation and coding scheme used for communications with the UE 104 based on the CSI.

A non-adaptive algorithm is deterministic as a function of its inputs. If the algorithm is faced with exactly the same inputs at different times, then its outputs will be exactly the same. An adaptive algorithm (e.g., machine learning or artificial intelligence) is one that changes its behavior based on its past experience. This means that different devices using the adaptive algorithm may end up with different algorithms as time passes.

According to certain aspects, the channel estimation and CSI feedback procedures may be performed using an adaptive learning-based algorithm (e.g., the machine learning module 510). Thus, over the time, the channel estimation and CSI feedback algorithm changes (e.g., adapts or updates) based on new learning. The channel estimation and CSI feedback procedures may be used for adapting various characteristics of the communication link between a UE and a network entity, such as transmit power control, modulation and coding scheme(s), code rate, subcarrier spacing, etc. For example, the adaptive learning can be used to determine a channel estimation and/or CSI feedback based on the transmission spatial information described herein. The adaptive learning may enable the UE to determine the channel estimation and/or CSI feedback based on a TxRU mapping to antenna elements (for example, the mapping(s) depicted in FIGS. 8-10) without knowing the exact antenna architecture at a network entity.

In some examples, the adaptive learning-based CSI/channel estimation involves training a model, such as a predictive model. The model may be used to determine the CSI/channel estimation associated with reference signals based on the transmission spatial information (e.g., a cover-code configuration) indicated by a network entity. The model may be trained based on training data (e.g., training information), which may include feedback, such as feedback associated with the CSI/channel estimation (e.g., measurements of reference signals).

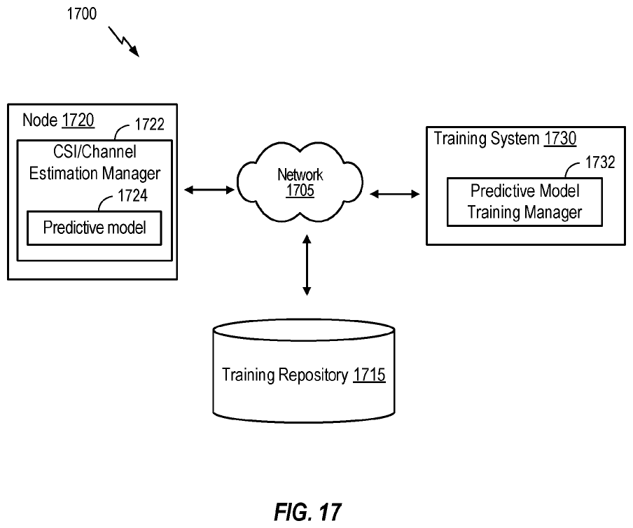

FIG. 17 illustrates an example networked environment 1700 in which a predictive model 1724 is used for determining CSI/channel estimation. As shown in FIG. 17, networked environment 1700 includes a node 1720, a training system 1730, and a training repository 1715, communicatively connected via network 1705. The node 1720 may be a UE (e.g., such as the UE 104 in the wireless communication network 100) or a BS (e.g., such as the BS 102 in the wireless communication network 100). The network 1705 may be a wireless network such as the wireless communication network 100, which may be a 5G NR network. While the training system 1730, node 1720, and training repository 1715 are illustrated as separate components in FIG. 17, it should be recognized by one of ordinary skill in the art that the training system 1730, node 1720, and training repository 1715 may be implemented on any number of computing systems, either as one or more standalone systems or in a distributed environment.

The training system 1730 generally includes a predictive model training manager 1732 that uses training data to generate a predictive model 1724 for determining CSI and/or a channel estimation based on certain transmission spatial information associated with a network entity. The predictive model 1724 may be determined based on the information in the training repository 1715.

The training repository 1715 may include training data obtained before and/or after deployment of the node 1720. The node 1720 may be trained in a simulated communication environment (e.g., in field testing, drive testing, etc.) prior to deployment of the node 1720. For example, various CSI and/or channel estimations (e.g., CQI, PMI, RSRP, SINR, etc.) can be tested in various scenarios, such as with different antenna architectures at a network entity, different TxRU to antenna element mappings used at a network entity, different cover-codes, at different UE speeds, with the UE stationary, at various rotations of the UE, with various BS deployments/geometries, etc., to obtain training information related to the CSI/channel estimation procedure. This information can be stored in the training repository 1715. After deployment, the training repository 1715 can be updated to include feedback associated with CSI/channel estimation procedures performed by the node 1720. The training repository can also be updated with information from other BSs and/or other UEs, for example, based on learned experience by those BSs and UEs, which may be associated with CSI/channel estimation procedures performed by those BSs and/or UEs.

The predictive model training manager 1732 may use the information in the training repository 1715 to determine the predictive model 1724 (e.g., algorithm) used for CSI/channel estimation, such as to determine CQI, PMI, RSRP, SINR, etc. As discussed in more detail herein, the predictive model training manager 1732 may use various different types of adaptive learning to form the predictive model 1724, such as machine learning, deep learning, reinforcement learning, etc. The training system 1730 may adapt (e.g., update/refine) the predictive model 1724 over time. For example, as the training repository is updated with new training information (e.g., feedback), the model 1724 is updated based on the new learning/experience.

The training system 1730 may be located on the node 1720, on a BS in the network 1705, or on a different entity that determines the predictive model 1724. If located on a different entity, then the predictive model 1724 is provided to the node 1720.

The training repository 1715 may be a storage device, such as a memory. The training repository 1715 may be located on the node 1720, the training system 1730, or another entity in the network 1705. The training repository 1715 may be in cloud storage. The training repository 1715 may receive training information from the node 1720, entities in the network 1705 (e.g., BSs or UEs in the network 1705), the cloud, or other sources.

As described above, the node 1720 is provided with (or generates, e.g., if the training system 1730 is implemented in the node 1720) the predictive model 1724. As illustrated, the node 1720 may include a CSI/channel estimation manager 1722 configured to use the predictive model 1724 for CSI/channel estimation based on the transmission spatial information described herein. In some examples, the node 1720 utilizes the predictive model 1724 to generate CSI and/or determine channel estimation based on the transmission spatial information. The predictive model 1724 is updated as the training system 1730 adapts the predictive model 1724 with new learning.

Thus, the CSI/channel estimation algorithm, using the predictive model 1724, of the node 1720 is adaptive learning-based, as the algorithm used by the node 1720 changes over time, even after deployment, based on experience/feedback the node 1720 obtains in deployment scenarios (and/or with training information provided by other entities as well).

According to certain aspects, the adaptive learning may use any appropriate learning algorithm. As mentioned above, the learning algorithm may be used by a training system (e.g., such as the training system 1730) to train a predictive model (e.g., such as the predictive model 1724) for an adaptive-learning based CSI/channel estimation algorithm used by a device (e.g., such as the node 1720) for determining CSI/channel estimation based on transmission spatial information described herein. In some examples, the adaptive learning algorithm is an adaptive machine learning algorithm, an adaptive reinforcement learning algorithm, an adaptive deep learning algorithm, an adaptive continuous infinite learning algorithm, or an adaptive policy optimization reinforcement learning algorithm (e.g., a proximal policy optimization (PPO) algorithm, a policy gradient, a trust region policy optimization (TRPO) algorithm, or the like). In some examples, the adaptive learning algorithm is modeled as a partially observable Markov Decision Process (POMDP). In some examples, the adaptive learning algorithm is implemented by an artificial neural network (e.g., a deep Q network (DQN) including one or more deep neural networks (DNNs)).

In some examples, the adaptive learning (e.g., used by the training system 1730) is performed using a neural network. Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

In some examples, the adaptive learning (e.g., used by the training system 1730) is performed using a deep belief network (DBN). DBNs are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input could be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

In some examples, the adaptive learning (e.g., used by the training system 1730) is performed using a deep convolutional network (DCN). DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods. DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

An artificial neural network, which may be composed of an interconnected group of artificial neurons (e.g., neuron models), is a computational device or represents a method performed by a computational device. These neural networks may be used for various applications and/or devices, such as Internet Protocol (IP) cameras, Internet of Things (IoT) devices, autonomous vehicles, and/or service robots. Individual nodes in the artificial neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation.” The weight values may initially be determined by an iterative flow of training data through the network (e.g., weight values are established during a training phase in which the network learns how to identify particular classes by their typical input data characteristics).

Different types of artificial neural networks can be used to implement adaptive learning (e.g., used by the training system 1730), such as recurrent neural networks (RNNs), multilayer perceptron (MLP) neural networks, convolutional neural networks (CNNs), and the like. RNNs work on the principle of saving the output of a layer and feeding this output back to the input to help in predicting an outcome of the layer. In MLP neural networks, data may be fed into an input layer, and one or more hidden layers provide levels of abstraction to the data. Predictions may then be made on an output layer based on the abstracted data. MLPs may be particularly suitable for classification prediction problems where inputs are assigned a class or label. Convolutional neural networks (CNNs) are a type of feed-forward artificial neural network. Convolutional neural networks may include collections of artificial neurons that each has a receptive field (e.g., a spatially localized region of an input space) and that collectively tile an input space. Convolutional neural networks have numerous applications. In particular, CNNs have broadly been used in the area of pattern recognition and classification. In layered neural network architectures, the output of a first layer of artificial neurons becomes an input to a second layer of artificial neurons, the output of a second layer of artificial neurons becomes an input to a third layer of artificial neurons, and so on. Convolutional neural networks may be trained to recognize a hierarchy of features. Computation in convolutional neural network architectures may be distributed over a population of processing nodes, which may be configured in one or more computational chains. These multi-layered architectures may be trained one layer at a time and may be fine-tuned using back propagation.

In some examples, when using an adaptive machine learning algorithm, the training system 1730 generates vectors from the information in the training repository 1715. In some examples, the training repository 1715 stores vectors. In some examples, the vectors map one or more features to a label. For example, the features may correspond to various deployment scenario patterns discussed herein, such as transmission spatial information, antenna architectures at a network entity, TxRU to antenna element mappings used at a network entity, different cover-codes, the UE mobility, speed, rotation, channel conditions, BS deployment/geometry in the network, etc. The label may correspond to the CSI/channel estimation (e.g., CQI, PMI, RSRP, SINR, etc.) associated with the features for performing CSI/channel estimation (e.g., transmission spatial information). The predictive model training manager 1732 may use the vectors to train the predictive model 1724 for the node 1720. As discussed above, the vectors may be associated with weights in the adaptive learning algorithm. As the learning algorithm adapts (e.g., updates), the weights applied to the vectors can also be changed. Thus, when the CSI/channel estimation procedure is performed again, under the same features (e.g., under the same set of conditions including transmission spatial information), the model may give the node 1720 a different result (e.g., different CQI, PMI, RSRP, SINR, etc.).

According to certain aspects, the adaptive learning based-beam management allows for continuous infinite learning. In some examples, the learning may be augmented with federated learning. For example, while some machine learning approaches use a centralized training data on a single machine or in a data center; with federated learning, the learning may be collaborative involving multiple devices to form the predictive model. With federated learning, training of the model can be done on the device, with collaborative learning from multiple devices. For example, referring back to FIG. 17, the node 1720 can receive training information and/or updated trained models, from various different devices.

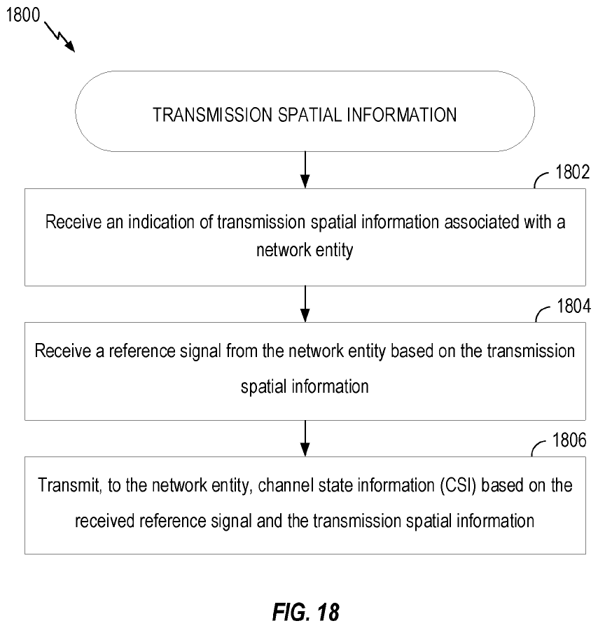

FIG. 18 is a flow diagram illustrating example operations 1800 for wireless communication, in accordance with certain aspects of the present disclosure. The operations 1800 may be performed, for example, by a UE (such as the UE 104 in the wireless communication network 100). The operations 1800 may be implemented as software components that are executed and run on one or more processors (e.g., controller/processor 280 of FIG. 2). Further, the transmission and reception of signals by the UE in operations 1800 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 1800 may optionally begin, at block 1802, where the UE may receive, from a network entity (e.g., the BS 102), an indication of transmission spatial information (e.g., the transmission spatial information 502) associated with the network entity. The transmission spatial information may include a mapping (e.g., the TxRU mapping described herein with respect to FIG. 8) of one or more TxRUs to one or more antenna elements (e.g., the antenna elements 804) of an antenna architecture (e.g., the antenna array 802) associated with the network entity.

At block 1804, the UE may receive, from the network entity, a reference signal (e.g., the reference signal(s) at activity 1604) from the network entity based on the transmission spatial information. The reference signal may include an SSB, CSI-RS, TRS, QCL reference signal, and/or training data, as described herein.

At block 1806, the UE may transmit, to the network entity, CSI (e.g., the CSI 508) based on the received reference signal and the transmission spatial information. For example, the CSI may indicate a CQI, a PMI, a RSRP, and/or SINR associated with the reference signal(s).

In certain aspects, the indication of the transmission spatial information may include a cover-code configuration, for example, as described herein with respect to FIG. 11. To receive the indication of the transmission spatial information, the UE may receive a cover-code configuration (e.g., the cover-code configuration at activity 1106) that identifies the transmission spatial information. The UE may receive the reference signal based on the cover-code configuration. For example, the UE may expect the TxRU mapping and/or beamforming applied to the reference signal and associated with the cover-code configuration. The cover-code configuration may identify a cover-code (e.g., the cover-code 526 and/or cover-code/beamformer 810) of the transmission spatial information. The antenna architecture at the network entity may be indicated via a CSI-RS port grouping (e.g., the CSI-RS port grouping 1122). The transmission spatial information may identify a cover-code that corresponds to CSI-RS ports (e.g., the CSI-RS ports 1126) arranged in groups (e.g., group(s) 1124 associated with the CSI-RS ports 1126). The UE may determine a channel estimation based on the received reference signal and the cover-code and/or determine the CSI based at least in part on the cover-code and/or the channel estimation. The UE may determine the channel estimation and/or CSI using the indication of the cover-code configuration. For example, the indication of the cover-code configuration may indicate which AI/ML module to use for channel estimation and/or CSI feedback. The UE may determine the CSI feedback using the indication of the cover-code configuration. For example, the indication of the cover-code configuration may indicate which AI/ML module to use for CSI feedback.

For certain aspects, the indication of the transmission spatial information may include an indication of a machine learning module, for example, as described herein with respect to FIG. 12. To receive the indication of the transmission spatial information, the UE may receive a signal indicating a machine learning module (e.g., the indication identifying the machine learning modules at activity 1204) associated with the transmission spatial information or associated with a cover-code indicating the transmission spatial information. The cover-code may be associated with an antenna architecture associated with the network entity. In some cases, the indication of the machine learning module may be indicated via a cover-code configuration. The UE may determine a channel estimation based on the received reference signal using the machine learning module and the cover-code and/or determine the CSI based at least in part on the cover-code and/or the channel estimation. The UE may determine the channel estimation and/or CSI using the indication of the machine learning module. For example, the indication of the machine learning module may indicate which AI/ML module to use for channel estimation and/or CSI feedback. In certain cases, the UE may determine determine a channel estimation based on the received reference signal using the machine learning module and the transmission spatial information and/or determine the CSI using the machine learning module and the transmission spatial information, where the machine learning module for the CSI may take as input the channel estimation and/or the received reference signal.

The artificial intelligence and/or machine learning modules at the UE may support a specific format for input and/or output, for example, as described herein with respect to FIG. 5. To determine the channel estimation and/or CSI, the UE may determine a frequency domain channel estimate for each of a plurality of ports associated with an antenna architecture using the machine learning module, which may take as input the received reference signal. To determine the frequency domain channel estimate for each of the ports, the UE may output, with the machine learning module, the frequency domain channel estimates in an order based on a port index, a resource block index, a reference subcarrier index of each resource block, a subcarrier index, or a symbol index, for example, according to the output order 520. To determine the frequency domain channel estimate for each of the ports, the UE may input the received reference signal in the machine learning module in an order based on a subcarrier index, a symbol index, or a receive antenna index, for example, according to the input order 518.

In certain cases, the UE may be configured with a list of machine learning modules supported by a network entity, for example, as described herein with respect to FIG. 12. The UE may receive a first signal indicating a plurality of machine learning modules (e.g., a list of machine learning modules) and indicating an association between each of the machine learning modules and a cover-code among a plurality of cover-codes. To receive the indication of the transmission spatial information, the UE may receive a second signal that identifies at least one of the machine learning modules associated with at least one of the cover-codes indicating the transmission spatial information. The indication of the transmission spatial information may trigger the UE to use one of the machine learning modules for channel estimation and/or CSI feedback. The UE may determine the channel estimation and/or CSI feedback using a machine learning module with a format for the input and/or output as described herein.

In certain aspects, the indication of the transmission spatial information may include an indication of QCL information, for example, as described herein with respect to FIG. 13. The QCL information may include an indication of a QCL reference signal and/or a QCL type (e.g., QCL-TypeE) associated with transmission spatial information. The QCL reference signal may include a pattern for a TRS or a CSI-RS, training data for a machine learning module, or any combination thereof. The QCL reference signal includes two or more ports, a band of one resource block to twenty-four resource blocks, and a periodicity (e.g., >640 slots or 640 milliseconds (ms)). In some cases, the periodicity may include 10 ms, 40 ms, 80 ms, 160 ms, 640 ms, etc. In certain cases, the periodicity may include 10 slots, 40 slots, 80 slots, 160 slots, 640 slots, etc.

To receive the indication of the transmission information, the UE may receive a signal indicating a QCL configuration (e.g., the QCL configuration 1320) for the reference signal. The QCL configuration may identify a transmit spatial relationship or parameter as a QCL Type (e.g., the QCL Type 1322) for the reference signal. The QCL configuration may identify a QCL reference signal (e.g., the SSB resource ID 1324 and/or the TRS resource ID 1326) having a QCL relationship with the reference signal. The QCL relationship may be the transmit spatial relationship or parameter associated with the QCL type. To receive the reference signal at block 1804, the UE may receive the QCL reference signal. The reference signal may include the QCL reference signal. In certain cases, the UE may determine the transmission spatial information based on the received reference signal in response to the reference signal having the QCL Type of the transmit spatial relationship. The UE may determine the transmission spatial information based on a spatial tracking loop of the QCL reference signal.

In certain aspects, the QCL information may be associated with a machine learning module. In some cases, the UE may train or select the machine learning module based on the QCL information. The UE may determine a channel estimation based on the received reference signal using a machine learning module and the transmission spatial information and/or determine the CSI based at least in part on the transmission spatial information and/or channel estimation. In some cases, the UE may the CSI based at least in part on the transmission spatial information (e.g., the QCL reference signal) using the machine leaning module, which may take as input the QCL reference signal and/or the channel estimation. The UE may select the machine learning module among a plurality of machine learning modules based on a measured transmit spatial relationship of the received reference signal in response to the QCL configuration.

For certain aspects, the indication of the transmission spatial information may include an indication of an in-distribution configuration and/or training data, for example, as described herein with respect to FIGS. 14 and 15. To receive the indication of the transmission spatial information, the UE may receive an in-distribution configuration (e.g., the indication at activity 1418 or 1516) indicating that the reference signal is conveyed via a channel or signal with a same distribution as training data (e.g., the training data at activity 1404) for a machine learning module. The training data may be indicative of the transmission spatial information. The UE may receive the training data for the machine learning module. In some cases, the in-distribution configuration may indicate the training data to use for the machine learning module. The UE may determine a channel estimation based on the received reference signal and the in-distribution configuration and/or determine the CSI based at least in part on the in-distribution configuration and/or the channel estimation. In some cases, the UE may determine the CSI based at least in part on the in-distribution configuration using the machine learning module, which may take as input the received reference signal and/or the channel estimation. The UE may determine the channel estimation and/or CSI feedback using a machine learning module with a format for the input and/or output as described herein.

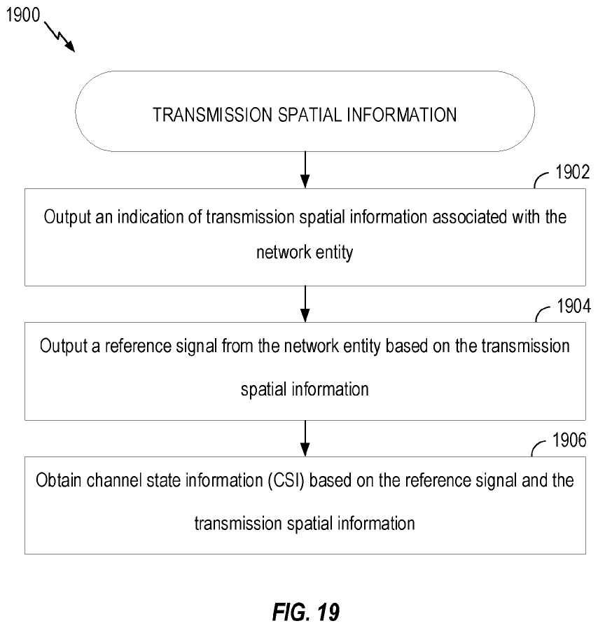

FIG. 19 is a flow diagram illustrating example operations 1900 for wireless communication, in accordance with certain aspects of the present disclosure. The operations 1900 may be performed, for example, by a network entity (such as the BS 102 in the wireless communication network 100). The operations 1900 may be complementary to the operations 1800 performed by the UE. The operations 1900 may be implemented as software components that are executed and run on one or more processors (e.g., controller/processor 240 of FIG. 2). Further, the transmission and reception of signals by the network entity in operations 1900 may be enabled, for example, by one or more antennas (e.g., antennas 234 of FIG. 2). In certain aspects, the transmission and/or reception of signals by the network entity may be implemented via a bus interface of one or more processors (e.g., controller/processor 240) obtaining and/or outputting signals.

The operations 1900 may optionally begin, at block 1902, where the network entity may output (e.g., transmit, provide, or send), to a UE (e.g., the UE 104), an indication of transmission spatial information associated with the network entity. The transmission spatial information may include a mapping (e.g., the TxRU mapping described herein with respect to FIG. 8) of one or more TxRUs to one or more antenna elements (e.g., the antenna elements 804) of an antenna architecture (e.g., the antenna array 802) associated with the network entity.

At block 1904, the network entity may output, to the UE, a reference signal from the network entity based on the transmission spatial information. The reference signal may include an SSB, CSI-RS, TRS, QCL reference signal, and/or training data, as described herein.

At block 1906, the network entity may obtain (e.g., receive), from the UE, CSI based on the reference signal and the transmission spatial information. For example, the CSI may indicate a CQI, a PMI, a RSRP, and/or SINR associated with the reference signal(s). In some cases, the network entity may adjust a configuration at the UE based on the CSI. For example, the network entity may adjust the modulation and coding scheme configured at the UE based on the CSI.

In certain aspects, the indication of the transmission spatial information may include a cover-code configuration, for example, as described herein with respect to FIG. 11. To output the indication of the transmission spatial information, the network entity may output, to the UE, a cover-code configuration that identifies the transmission spatial information, and the network entity may output the reference signal based on the cover-code configuration. The cover-code configuration may identify a cover-code of the transmission spatial information. The transmission spatial information may identify a cover-code that corresponds to CSI-RS ports (e.g., the CSI-RS ports 1126) arranged in groups (e.g., groups 1124 associated with certain CSI-RS resource ID(s)).

For certain aspects, the indication of the transmission spatial information may include an indication of a machine learning module, for example, as described herein with respect to FIG. 12. To output the indication of the transmission spatial information, the network entity may output, to the UE, a signal that indicates a machine learning module associated with a cover-code indicating the transmission spatial information. The cover-code may be associated with an antenna architecture associated with the network entity.

In certain cases, the network entity may configure the UE with a list of machine learning modules supported by the network entity, for example, as described herein with respect to FIG. 12. The network entity may output, to the UE, a first signal indicating a plurality of machine learning modules (e.g., a list of machine learning modules) and indicating an association between each of the machine learning modules and a cover-code among a plurality of cover-codes. To output the indication of the transmission spatial information, the network entity may output a second signal that identifies at least one of the machine learning modules associated with at least one of the cover-codes, indicating the transmission spatial information.

In certain aspects, the indication of the transmission spatial information may include an indication of QCL information, for example, as described herein with respect to FIG. 13. The QCL information may include an indication of a QCL reference signal and/or a QCL type (e.g., QCL-TypeE) associated with transmission spatial information. The QCL reference signal may include a pattern for a TRS or a CSI-RS, training data for a machine learning module, or any combination thereof. The QCL reference signal includes two or more ports, a band of one resource block to twenty-four resource blocks, and a periodicity (e.g., >640 slots).

To output the indication of the transmission spatial information, the network entity may output a signal indicating a QCL configuration (e.g., the QCL configuration 1320) for the reference signal. The QCL configuration may identify a transmit spatial relationship or parameter as a QCL Type (e.g., the QCL Type 1322) for the reference signal. The QCL configuration may identify a QCL reference signal (e.g., the SSB resource ID 1324 and/or the TRS resource ID 1326) having a QCL relationship with the reference signal. To output the reference signal, the network entity may output the QCL reference signal.

For certain aspects, the indication of the transmission spatial information may include an indication of an in-distribution configuration and/or training data, for example, as described herein with respect to FIGS. 14 and 15. To output the indication of the transmission spatial information, the network entity may output an in-distribution configuration indicating that the reference signal is conveyed via a channel or signal with a same distribution as training data for a machine learning module. The training data may be indicative of the transmission spatial information. The network entity may output, to the UE, the training data for the machine learning module. The in-distribution configuration may further indicate training data to use for the machine learning module.

### Example Wireless Communication Devices

FIG. 20 depicts an example communications device 2000 that includes various components operable, configured, or adapted to perform operations for the techniques disclosed herein, such as the operations depicted and described with respect to FIGS. 5-18. In some examples, communication device 2000 may be a UE 104 as described, for example with respect to FIGS. 1 and 2.

Communications device 2000 includes a processing system 2002 coupled to a transceiver 2008 (e.g., a transmitter and/or a receiver). Transceiver 2008 is configured to transmit (or send) and receive signals for the communications device 2000 via an antenna 2010, such as the various signals as described herein. Processing system 2002 may be configured to perform processing functions for communications device 2000, including processing signals received and/or to be transmitted by communications device 2000.

Processing system 2002 includes one or more processors 2020 coupled to a computer-readable medium/memory 2030 via a bus 2006. In certain aspects, computer-readable medium/memory 2030 is configured to store executable instructions (e.g., computer-executable code) that when executed by the one or more processors 2020, cause the one or more processors 2020 to perform the operations illustrated in FIGS. 5-18, or other operations for performing the various techniques discussed herein for indicating transmission spatial information.

In the depicted example, computer-readable medium/memory 2030 stores code 2031 for receiving, code 2032 for transmitting, code 2033 for determining, code 2034 for inputting, code 2035 for outputting, and/or code 2036 for selecting.

In the depicted example, the one or more processors 2020 include circuitry configured to implement the code stored in the computer-readable medium/memory 2030, including circuitry 2021 for receiving, circuitry 2022 for transmitting, circuitry 2023 for determining, circuitry 2024 for inputting, circuitry 2025 for outputting, and/or circuitry 2026 for selecting.

Various components of communications device 2000 may provide means for performing the methods described herein, including with respect to FIGS. 5-18.

In some examples, means for transmitting or sending (or means for outputting for transmission) may include the transceivers 254 and/or antenna(s) 252 of the UE 104 illustrated in FIG. 2 and/or transceiver 2008 and antenna 2010 of the communication device 2000 in FIG. 20.

In some examples, means for receiving (or means for obtaining) may include the transceivers 254 and/or antenna(s) 252 of the UE 104 illustrated in FIG. 2 and/or transceiver 2008 and antenna 2010 of the communication device 2000 in FIG. 20.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for receiving, means for transmitting, means for determining, means for inputting, means for outputting, and/or means for selecting may include various processing system components, such as the one or more processors 2020 in FIG. 20, or aspects of the UE 104 depicted in FIG. 2, including receive processor 258, transmit processor 264, TX MIMO processor 266, and/or controller/processor 280 (including the transmission spatial information component 281).

Notably, FIG. 20 is an example, and many other examples and configurations of communication device 2000 are possible.

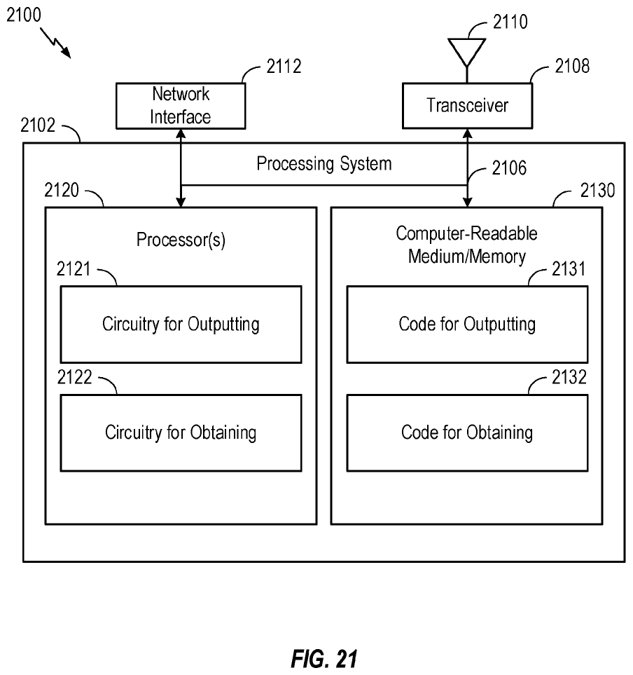

FIG. 21 depicts an example communications device 2100 that includes various components operable, configured, or adapted to perform operations for the techniques disclosed herein, such as the operations depicted and described with respect to FIGS. 5-17 and 19. In some examples, communication device 2100 may be a BS 102 as described, for example with respect to FIGS. 1 and 2.

Communications device 2100 includes a processing system 2102 coupled to a transceiver 2108 (e.g., a transmitter and/or a receiver) and/or a network interface 2112. The transceiver 2108 is configured to transmit (or send) and receive signals for the communications device 2100 via an antenna 2110, such as the various signals as described herein. The network interface 2112 is configured to obtain and send signals for the communications device 2100 via communications link(s), such as a backhaul link, midhaul link, and/or fronthaul link as described herein, such as with respect to FIG. 4. Processing system 2102 may be configured to perform processing functions for communications device 2100, including processing signals received and/or to be transmitted by communications device 2100.

Processing system 2102 includes one or more processors 2120 coupled to a computer-readable medium/memory 2130 via a bus 2106. In certain aspects, computer-readable medium/memory 2130 is configured to store executable instructions (e.g., computer-executable code) that when executed by the one or more processors 2120, cause the one or more processors 2120 to perform the operations illustrated in FIGS. 5-17 and 19, or other operations for performing the various techniques discussed herein for indicating transmission spatial information.

In the depicted example, computer-readable medium/memory 2130 stores code 2131 for outputting (e.g., transmitting, sending, or providing) and/or code 2132 for obtaining.

In the depicted example, the one or more processors 2120 include circuitry configured to implement the code stored in the computer-readable medium/memory 2130, including circuitry 2121 for outputting and/or circuitry 2122 for obtaining.

Various components of communications device 2100 may provide means for performing the methods described herein, including with respect to FIGS. 5-17 and 19.

In some examples, means for transmitting or outputting (or means for outputting for transmission) may include the transceivers 232 and/or antenna(s) 234 of the BS 102 illustrated in FIG. 2 and/or transceiver 2108 and antenna 2110 of the communication device 2100 in FIG. 21.

In some examples, means for receiving (or means for obtaining) may include the transceivers 232 and/or antenna(s) 234 of the base station illustrated in FIG. 2 and/or transceiver 2108 and antenna 2110 of the communication device 2100 in FIG. 21.

In some examples, means for sending and/or means for obtaining may include various processing system components, such as the one or more processors 2120 in FIG. 21, or aspects of the BS 102 depicted in FIG. 2, including receive processor 238, transmit processor 220, TX MIMO processor 230, and/or controller/processor 240 (including the transmission spatial information component 241).

Notably, FIG. 21 is an example, and many other examples and configurations of communication device 2100 are possible.

### Example Aspects

Implementation examples are described in the following numbered clauses:

Aspect 1: An apparatus for wireless communication, comprising: a memory; and a processor coupled to the memory, the processor configured to: receive an indication of transmission spatial information associated with a network entity; receive a reference signal from the network entity based on the transmission spatial information; and transmit, to the network entity, channel state information (CSI) based on the received reference signal and the transmission spatial information.

Aspect 2: The apparatus of Aspect 1, further comprising a transceiver configured to receive the indication of the transmission spatial information, receive the reference signal, and transmit the CSI, wherein the transmission spatial information indicates a mapping of one or more transceiver units (TxRUs) to one or more antenna elements of an antenna architecture associated with the network entity.

Aspect 3: The apparatus of Aspect 1 or 2, wherein: to receive the indication of the transmission spatial information, the processor is further configured to receive a cover-code configuration that identifies the transmission spatial information; and to receive the reference signal, the processor is further configured to receive the reference signal based on the cover-code configuration.

Aspect 4: The apparatus of Aspect 3, wherein the cover-code configuration identifies a cover-code of the transmission spatial information.

Aspect 5: The apparatus of Aspect 4, wherein the processor is further configured to at least one of: determine a channel estimation based on the received reference signal and the cover-code; or determine the CSI based at least in part on the cover-code.

Aspect 6: The apparatus according to any of Aspects 3-5, wherein the transmission spatial information identifies a cover-code that corresponds to channel state information reference signal (CSI-RS) ports arranged in groups.

Aspect 7: The apparatus according to any of Aspects 1-6, wherein to receive the indication of the transmission spatial information, the processor is further configured to receive a signal indicating a machine learning module associated with the transmission spatial information.

Aspect 8: The apparatus of Aspect 7, wherein the machine learning module is indicated via a cover-code configuration.

Aspect 9: The apparatus of Aspect 7 or 8, wherein the processor is further configured to at least one of: determine a channel estimation based on the received reference signal using the machine learning module and the transmission spatial information; or determine the CSI using the transmission spatial information and the machine learning module.

Aspect 10: The apparatus of Aspect 9, wherein to determine the channel estimation, the processor is further configured to determine a frequency domain channel estimate for each of a plurality of ports associated with an antenna architecture using the machine learning module, wherein input of the machine learning module includes the received reference signal.

Aspect 11: The apparatus according to any of Aspects 1-10, wherein to receive the indication of the transmission spatial information, the processor is further configured receive a signal indicating a quasi co-location (QCL) configuration for the reference signal, wherein the QCL configuration identifies a transmit spatial relationship as a QCL Type for the reference signal.

Aspect 12: The apparatus of Aspect 11, wherein the processor is further configured to determine the transmission spatial information based on the received reference signal in response to the reference signal having the QCL Type of the transmit spatial relationship.

Aspect 13: The apparatus of Aspect 11 or 12, wherein the processor is further configured to at least one of: determine a channel estimation based on the received reference signal using a machine learning module and the transmission spatial information; or determine the CSI based at least in part on the transmission spatial information using the machine learning module.

Aspect 14: The apparatus of Aspect 13, wherein the processor is further configured to select the machine learning module among a plurality of machine learning modules based on a measured transmit spatial relationship of the received reference signal.

Aspect 15: The apparatus according to any of Aspects 1-14, wherein to receive the indication of the transmission spatial information, the processor is further configured to receive an in-distribution configuration indicating that the reference signal is conveyed via a channel with a same distribution as training data for a machine learning module, wherein the training data is indicative of the transmission spatial information.

Aspect 16: The apparatus of Aspect 15, wherein the processor is further configured to: receive the training data for the machine learning module, wherein the in-distribution configuration further indicates the training data to use for the machine learning module; train the machine learning module using the training data; and determine the CSI using the trained machine learning module.

Aspect 17: An apparatus for wireless communication, comprising: a memory; and a processor configured to: output an indication of transmission spatial information associated with the apparatus, output a reference signal based on the transmission spatial information, and obtain channel state information (CSI) based on the reference signal and the transmission spatial information.

Aspect 18: The apparatus of Aspect 17, further comprising a transceiver configured to output the indication of the transmission spatial information, output the reference signal, and obtain the CSI, wherein the transmission spatial information indicates a mapping of one or more transceiver units (TxRUs) to one or more antenna elements of an antenna architecture associated with the apparatus.

Aspect 19: The apparatus of Aspect 17 or 18, wherein: to output the indication of the transmission spatial information, the processor is further configured to output a cover-code configuration that identifies the transmission spatial information; and to output the reference signal, the processor is further configured to output the reference signal based on the cover-code configuration.

Aspect 20: The apparatus of Aspect 19, wherein the cover-code configuration identifies a cover-code of the transmission spatial information.

Aspect 21: The apparatus of Aspect 19 or 20, wherein the transmission spatial information identifies a cover-code that corresponds to channel state information reference signal (CSI-RS) ports arranged in groups.

Aspect 22: The apparatus according to any of Aspects 17-21, wherein to output the indication of the transmission spatial information, the processor is further configured to output a signal that indicates a machine learning module associated with the transmission spatial information.

Aspect 23: The apparatus of Aspect 22, wherein the machine learning module is indicated via a cover-code configuration.

Aspect 24: The apparatus according to any of Aspects 17-23, wherein: the processor is further configured to output a first signal indicating a plurality of machine learning modules and indicating an association between each of the machine learning modules and a cover-code among a plurality of cover-codes; and to output the indication of the transmission spatial information, the processor is further configured to output a second signal that identifies at least one of the machine learning modules associated with at least one of the cover-codes, indicating the transmission spatial information.

Aspect 25: The apparatus according to any of Aspects 17-24, wherein to output the indication of the transmission spatial information, the processor is further configured to output a signal indicating a quasi co-location (QCL) configuration for the reference signal, wherein the QCL configuration identifies a transmit spatial relationship as a QCL Type for the reference signal.

Aspect 26: The apparatus according to any of Aspects 17-25, wherein to output the indication of the transmission spatial information, the processor is further configured to output an in-distribution configuration indicating that the reference signal is conveyed via a channel with a same distribution as training data for a machine learning module, wherein the training data is indicative of the transmission spatial information.

Aspect 27: The apparatus of Aspect 26, wherein the processor is further configured to output the training data for the machine learning module, wherein the in-distribution configuration further indicates the training data to use for the machine learning module.

Aspect 28: A method of wireless communication by a user equipment, comprising: receiving an indication of transmission spatial information associated with a network entity; receiving a reference signal from the network entity based on the transmission spatial information; and transmitting, to the network entity, channel state information (CSI) based on the received reference signal and the transmission spatial information.

Aspect 29: The method of Aspect 28, wherein the transmission spatial information includes a mapping of one or more transceiver units (TxRUs) to one or more antenna elements of an antenna architecture associated with the network entity.

Aspect 30: The method of Aspect 28 or 29, wherein: receiving the indication of the transmission spatial information comprises receiving a cover-code configuration that identifies the transmission spatial information; and receiving the reference signal comprises receiving the reference signal based on the cover-code configuration.

Aspect 31: The method of Aspect 30, wherein the cover-code configuration identifies a cover-code of the transmission spatial information.

Aspect 32: The method of Aspect 31, further comprising: determining a channel estimation based on the received reference signal and the cover-code; or determining the CSI based at least in part on the cover-code.

Aspect 33: The method of Aspect 31, further comprising: determining a channel estimation based on the received reference signal and the cover-code; and determining the CSI based at least in part on the channel estimation.

Aspect 34: The method according to any of Aspects 30-33, wherein the transmission spatial information identifies a cover-code that corresponds to channel state information reference signal (CSI-RS) ports arranged in groups.

Aspect 35: The method according to any of Aspects 28-34, wherein receiving the indication of the transmission spatial information comprises receiving a signal indicating a machine learning module associated with the transmission spatial information.

Aspect 36: The method of Aspect 35, wherein the machine learning module is indicated via a cover-code configuration.

Aspect 37: The method of Aspect 35 or 36, further comprising: determining a channel estimation based on the received reference signal using the machine learning module and the transmission spatial information; or determining the CSI using the transmission spatial information and the machine learning module.

Aspect 38: The method of Aspect 35 or 36, further comprising: determining a channel estimation based on the received reference signal using the machine learning module and the transmission spatial information; and determining the CSI based at least in part on the channel estimation.

Aspect 39: The method of Aspect 37 or 38, wherein determining the channel estimation comprises determining a frequency domain channel estimate for each of a plurality of ports associated with an antenna architecture using the machine learning module, wherein the machine learning module takes as input the received reference signal.

Aspect 40: The method of Aspect 39, wherein determining the frequency domain channel estimate for each of the ports comprises outputting, with the machine learning module, the frequency domain channel estimates in an order based on a port index, a resource block index, a reference subcarrier index of each resource block, a subcarrier index, or a symbol index.

Aspect 41: The method of Aspect 40, wherein determining the frequency domain channel estimate for each of the ports comprises inputting the received reference signal in the machine learning module in an order based on a subcarrier index or a symbol index.

Aspect 42: The method according to any of Aspects 28-41, further comprising: receiving a first signal indicating a plurality of machine learning modules and indicating an association between each of the machine learning modules and a cover-code among a plurality of cover-codes; and wherein receiving the indication of the transmission spatial information comprises receiving a second signal that identifies at least one of the machine learning modules associated with at least one of the cover-codes indicating the transmission spatial information.

Aspect 43: The method of Aspect 42, further comprising: determining a channel estimation based on the received reference signal using the at least one of the machine learning modules and the transmission spatial information; determining the CSI based at least in part on the channel estimation; and wherein determining the channel estimation comprises determining a frequency domain channel estimate for each of a plurality of ports associated with an antenna architecture using the at least one of the machine learning modules, wherein the at least one of the machine learning modules takes as input the received reference signal, wherein determining the frequency domain channel estimate for each of the ports comprises: outputting, with the at least one of the machine learning modules, the frequency domain channel estimates in an order based on a port index, a resource block index, a reference subcarrier index of each resource block, a subcarrier index, or a symbol index; and inputting the received reference signal in the at least one of the machine learning modules in an order based on a subcarrier index or a symbol index.

Aspect 44: The method according to any of Aspects 28-43, wherein receiving the indication of the transmission spatial information comprises receiving a signal indicating a quasi co-location (QCL) configuration for the reference signal, wherein the QCL configuration identifies a transmit spatial relationship as a QCL Type for the reference signal.

Aspect 45: The method of Aspect 44, wherein: the QCL configuration identifies a QCL reference signal having a QCL relationship with the reference signal; and receiving the reference signal comprises receiving the QCL reference signal.

Aspect 46: The method of Aspect 45, wherein the QCL reference signal includes: a pattern for a tracking reference signal or a CSI reference signal (CSI-RS); training data for a machine learning module; or any combination thereof.

Aspect 47: The method of Aspect 45 or 46, wherein the QCL reference signal includes two or more ports, a band of one resource block to twenty-four resource blocks, and a periodicity.

Aspect 48: The method according to any of Aspects 45-47, further comprising determining the transmission spatial information based on a spatial tracking loop of the QCL reference signal.

Aspect 49: The method according to any of Aspects 44-48, further comprising determining the transmission spatial information based on the received reference signal in response to the reference signal having the QCL Type of the transmit spatial relationship.

Aspect 50: The method according to any of Aspects 44-49, further comprising: determining a channel estimation based on the received reference signal using a machine learning module and the transmission spatial information; or determining the CSI based at least in part on the transmission spatial information using the machine learning module.

Aspect 51: The method of Aspect 50, further comprising selecting the machine learning module among a plurality of machine learning modules based on a measured transmit spatial relationship of the received reference signal.

Aspect 52: The method according to any of Aspects 28-51, wherein receiving the indication of the transmission spatial information comprises receiving an in-distribution configuration indicating that the reference signal is conveyed via a channel with a same distribution as training data for a machine learning module, wherein the training data is indicative of the transmission spatial information.

Aspect 53: The method of Aspect 52, further comprising: receiving the training data for the machine learning module, wherein the in-distribution configuration further indicates the training data to use for the machine learning module.

Aspect 54: The method of Aspect 52 or 53, further comprising: determining a channel estimation based on the received reference signal and the in-distribution configuration; or determining the CSI based at least in part on the in-distribution configuration.

Aspect 55: The method of Aspect 52 or 53, further comprising: determining a channel estimation based on the received reference signal and in-distribution configuration; and determining the CSI based at least in part on the channel estimation.

Aspect 56: The method of Aspect 54 or 55, wherein determining the channel estimation comprises: determining a frequency domain channel estimate for each of a plurality of ports associated with an antenna architecture using the machine learning module, wherein the machine learning module takes as input the received reference signal and the training data.

Aspect 57: The method of Aspect 56, wherein determining the frequency domain channel estimate for each of the ports associated with the antenna architecture comprises: inputting the received reference signal and the training data in the machine learning module in an order based on a subcarrier index or a symbol index; and outputting, with the machine learning module, the frequency domain channel estimates in an order based on a port index, a resource block index, a reference subcarrier index of each resource block, the subcarrier index, or the symbol index.

Aspect 58: The method according to any of Aspects 53-57, further comprising: training the machine learning module using the training data; determining a channel estimation based on the received reference signal using the machine learning module; and determining the CSI based at least in part on the channel estimation.

Aspect 59: A method of wireless communication by a network entity, comprising: outputting an indication of transmission spatial information associated with the network entity; outputting a reference signal based on the transmission spatial information; and obtaining channel state information (CSI) based on the reference signal and the transmission spatial information.

Aspect 60: The method of Aspect 59, wherein the transmission spatial information includes a mapping of one or more transceiver units (TxRUs) to one or more antenna elements of an antenna architecture associated with the network entity.

Aspect 61: The method of Aspect 59 or 60, wherein: outputting the indication of the transmission spatial information comprises outputting a cover-code configuration that identifies the transmission spatial information; and outputting the reference signal comprises outputting the reference signal based on the cover-code configuration.

Aspect 62: The method of Aspect 61, wherein the cover-code configuration identifies a cover-code of the transmission spatial information.

Aspect 63: The method of Aspect 61 or 62, wherein the transmission spatial information identifies a cover-code that corresponds to channel state information reference signal (CSI-RS) ports arranged in groups.

Aspect 64: The method according to any of Aspects 59-63, wherein outputting the indication of the transmission spatial information comprises outputting a signal that indicates a machine learning module associated with the transmission spatial information.

Aspect 65: The method of Aspect 64, wherein the machine learning module is indicated via a cover-code configuration.

Aspect 66: The method according to any of Aspects 59-65, further comprising: outputting a first signal indicating a plurality of machine learning modules and indicating an association between each of the machine learning modules and a cover-code among a plurality of cover-codes; and wherein outputting the indication of the transmission spatial information comprises outputting a second signal that identifies at least one of the machine learning modules associated with at least one of the cover-codes, indicating the transmission spatial information.

Aspect 67: The method according to any of Aspects 59-66, wherein outputting the indication of the transmission spatial information comprises outputting a signal indicating a quasi co-location (QCL) configuration for the reference signal, wherein the QCL configuration identifies a transmit spatial relationship as a QCL Type for the reference signal.

Aspect 68: The method of Aspect 67, wherein: the QCL configuration identifies a QCL reference signal having a QCL relationship with the reference signal; and outputting the reference signal comprises outputting the QCL reference signal.

Aspect 69: The method of Aspect 68, wherein the QCL reference signal includes: a pattern for a tracking reference signal or a CSI reference signal (CSI-RS); training data for a machine learning module; or any combination thereof.

Aspect 70: The method of Aspect 68 or 69, wherein the QCL reference signal includes two or more ports, a band of one resource block to twenty-four resource blocks, and a periodicity.

Aspect 71: The method according to any of Aspects 59-70, wherein outputting the indication of the transmission spatial information comprises outputting an in-distribution configuration indicating that the reference signal is conveyed via a channel with a same distribution as training data for a machine learning module, wherein the training data is indicative of the transmission spatial information.

Aspect 72: The method of Aspect 71, further comprising outputting the training data for the machine learning module, wherein the in-distribution configuration further indicates the training data to use for the machine learning module.

Aspect 73: An apparatus, comprising: a memory; and a processor coupled to the memory, the processor being configured to perform a method in accordance with any of Aspects 28-72.

Aspect 74: An apparatus, comprising means for performing a method in accordance with any of Aspects 28-72.

Aspect 75: A non-transitory computer-readable medium comprising computer-executable instructions that, when executed by one or more processors of a processing system, cause the processing system to perform a method in accordance with any of Aspects 1-23.

Aspect 76: A computer program product embodied on a computer-readable storage medium comprising code for performing a method in accordance with any of Aspects 28-72.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as BS 180 (e.g., gNB) may operate in a traditional sub-6 GHz spectrum, in millimeter wave (mmWave) frequencies, and/or near mmWave frequencies in communication with the UE 104. When the BS 180 operates in mm Wave or near mm Wave frequencies, the BS 180 may be referred to as an mmWave base station.

The communication links 120 between BSs 102 and, for example, UEs 104, may be through one or more carriers. For example, BSs 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communication network 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Transmit processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A, 3B, 3C, and 3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A, 3B, 3C, and 3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

Referring to FIG. 4, each of the units, e.g., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUS 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via 01) or via creation of RAN management policies (such as A1 policies).

### Additional Considerations

The preceding description provides examples of channel estimation and/or channel state information reporting in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a user equipment (as in the example UE 104 of FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, comprising:
a memory; and
a processor coupled to the memory, the processor configured to:
receive an indication of transmission spatial information associated with a network entity;
receive a reference signal from the network entity based on the transmission spatial information; and
transmit, to the network entity, channel state information (CSI) based on the received reference signal and the transmission spatial information.

2. The apparatus of claim 1, further comprising a transceiver configured to receive the indication of the transmission spatial information, receive the reference signal, and transmit the CSI, wherein the transmission spatial information indicates a mapping of one or more transceiver units (TxRUs) to one or more antenna elements of an antenna architecture associated with the network entity.

3. The apparatus of claim 1, wherein:
to receive the indication of the transmission spatial information, the processor is further configured to receive a cover-code configuration that identifies the transmission spatial information; and
to receive the reference signal, the processor is further configured to receive the reference signal based on the cover-code configuration.

4. The apparatus of claim 3, wherein the cover-code configuration identifies a cover-code of the transmission spatial information.

5. The apparatus of claim 4, wherein the processor is further configured to at least one of:
determine a channel estimation based on the received reference signal and the cover-code; or
determine the CSI based at least in part on the cover-code.

6. The apparatus of claim 3, wherein the transmission spatial information identifies a cover-code that corresponds to channel state information reference signal (CSI-RS) ports arranged in groups.

7. The apparatus of claim 1, wherein to receive the indication of the transmission spatial information, the processor is further configured to receive a signal indicating a machine learning module associated with the transmission spatial information.

8. The apparatus of claim 7, wherein the machine learning module is indicated via a cover-code configuration.

9. The apparatus of claim 7, wherein the processor is further configured to at least one of:
determine a channel estimation based on the received reference signal using the machine learning module and the transmission spatial information; or
determine the CSI using the transmission spatial information and the machine learning module.

10. The apparatus of claim 9, wherein to determine the channel estimation, the processor is further configured to determine a frequency domain channel estimate for each of a plurality of ports associated with an antenna architecture using the machine learning module, wherein input of the machine learning module includes the received reference signal.

11. The apparatus of claim 1, wherein to receive the indication of the transmission spatial information, the processor is further configured receive a signal indicating a quasi co-location (QCL) configuration for the reference signal, wherein the QCL configuration identifies a transmit spatial relationship as a QCL Type for the reference signal.

12. The apparatus of claim 11, wherein the processor is further configured to determine the transmission spatial information based on the received reference signal in response to the reference signal having the QCL Type of the transmit spatial relationship.

13. The apparatus of claim 11, wherein the processor is further configured to at least one of:
determine a channel estimation based on the received reference signal using a machine learning module and the transmission spatial information; or
determine the CSI based at least in part on the transmission spatial information using the machine learning module.

14. The apparatus of claim 13, wherein the processor is further configured to select the machine learning module among a plurality of machine learning modules based on a measured transmit spatial relationship of the received reference signal.

15. The apparatus of claim 1, wherein to receive the indication of the transmission spatial information, the processor is further configured to receive an in-distribution configuration indicating that the reference signal is conveyed via a channel with a same distribution as training data for a machine learning module, wherein the training data is indicative of the transmission spatial information.

16. The apparatus of claim 15, wherein the processor is further configured to:
receive the training data for the machine learning module, wherein the in-distribution configuration further indicates the training data to use for the machine learning module;
train the machine learning module using the training data; and
determine the CSI using the trained machine learning module.

17. An apparatus for wireless communication, comprising:
a memory; and
a processor configured to:
output an indication of transmission spatial information associated with the apparatus,
output a reference signal based on the transmission spatial information, and
obtain channel state information (CSI) based on the reference signal and the transmission spatial information.

18. The apparatus of claim 17, further comprising a transceiver configured to output the indication of the transmission spatial information, output the reference signal, and obtain the CSI, wherein the transmission spatial information indicates a mapping of one or more transceiver units (TxRUs) to one or more antenna elements of an antenna architecture associated with the apparatus.

19. The apparatus of claim 17, wherein:
to output the indication of the transmission spatial information, the processor is further configured to output a cover-code configuration that identifies the transmission spatial information; and
to output the reference signal, the processor is further configured to output the reference signal based on the cover-code configuration.

20. The apparatus of claim 19, wherein the cover-code configuration identifies a cover-code of the transmission spatial information.

21. The apparatus of claim 19, wherein the transmission spatial information identifies a cover-code that corresponds to channel state information reference signal (CSI-RS) ports arranged in groups.

22. The apparatus of claim 17, wherein to output the indication of the transmission spatial information, the processor is further configured to output a signal that indicates a machine learning module associated with the transmission spatial information.

23. The apparatus of claim 22, wherein the machine learning module is indicated via a cover-code configuration.

24. The apparatus of claim 17, wherein:
the processor is further configured to output a first signal indicating a plurality of machine learning modules and indicating an association between each of the machine learning modules and a cover-code among a plurality of cover-codes; and
to output the indication of the transmission spatial information, the processor is further configured to output a second signal that identifies at least one of the machine learning modules associated with at least one of the cover-codes, indicating the transmission spatial information.

25. The apparatus of claim 17, wherein to output the indication of the transmission spatial information, the processor is further configured to output a signal indicating a quasi co-location (QCL) configuration for the reference signal, wherein the QCL configuration identifies a transmit spatial relationship as a QCL Type for the reference signal.

26. The apparatus of claim 17, wherein to output the indication of the transmission spatial information, the processor is further configured to output an in-distribution configuration indicating that the reference signal is conveyed via a channel with a same distribution as training data for a machine learning module, wherein the training data is indicative of the transmission spatial information.

27. The apparatus of claim 26, wherein the processor is further configured to output the training data for the machine learning module, wherein the in-distribution configuration further indicates the training data to use for the machine learning module.

28. A method of wireless communication by a user equipment, comprising:
receiving an indication of transmission spatial information associated with a network entity;
receiving a reference signal from the network entity based on the transmission spatial information; and
transmitting, to the network entity, channel state information (CSI) based on the received reference signal and the transmission spatial information.

29. The method of claim 30, wherein the transmission spatial information indicates a mapping of one or more transceiver units (TxRUs) to one or more antenna elements of an antenna architecture associated with the network entity.

30. A method of wireless communication by a network entity, comprising:
outputting an indication of transmission spatial information associated with the network entity;
outputting a reference signal based on the transmission spatial information; and
obtaining channel state information (CSI) based on the reference signal and the transmission spatial information.
